(19) United States
(12) Patent Application Publication
(10) Pub. No.: US 2025/0267642 A1
(43) Pub. Date: Aug. 21, 2025

(54) UPLINK SUBBAND PROCESSING METHOD, CONFIGURATION METHOD, AND APPARATUS, TERMINAL, AND NETWORK-SIDE DEVICE

(71) Applicant: VIVO MOBILE COMMUNICATION CO., LTD., Guangdong (CN)

(72) Inventors: Chaojun ZENG, Guangdong (CN); Lihui WANG, Guangdong (CN)

(73) Assignee: VIVO MOBILE COMMUNICATION CO., LTD., Guangdong (CN)

(21) Appl. No.: 19/202,414

(22) Filed: May 8, 2025

Related U.S. Application Data
(63) Continuation of application No. PCT/CN2023/128031, filed on Oct. 31, 2023.

(30) Foreign Application Priority Data
Nov. 11, 2022 (CN) 202211414754.2

(51) Int. Cl. H04W 72/0453; H04L 5/14; H04W 72/0457

(52) U.S. Cl. CPC H04W 72/0453; H04L 5/14; H04W 72/0457

(57) ABSTRACT

This application discloses an uplink subband processing method, configuration method, and apparatus, a terminal, and a network-side device. The uplink subband processing method according to embodiments of this application includes: A terminal determines, based on an uplink subband configured by a network-side device, a frequency-domain resource available for an SBFD operation within a first bandwidth part BWP in a target SBFD time-domain unit, where the uplink subband is used for the SBFD operation; and the first BWP is one of BWPs corresponding to a target BWP pair.

### CROSS-REFERENCE TO RELATED APPLICATIONS

This application is a continuation application of PCT International Application No. PCT/CN 2023/128031 filed on Oct. 31, 2023, which claims priority to Chinese Patent Application No. 202211414754.2 filed on Nov. 11, 2022, which is incorporated herein by reference in its entirety.

### TECHNICAL FIELD

This application relates to the field of communication technologies, and specifically, to an uplink subband processing method, configuration method, and apparatus, a terminal, and a network-side device.

### BACKGROUND

A flexible duplex mode has been introduced to utilize limited frequency spectrum resources more flexibly, in order to dynamically adapt to service requirements, and improve resource utilization efficiency. A flexible duplex mode (non-overlapping subband full duplex, SBFD) is specifically that: full duplex operation at a network side and half-duplex operation at a terminal side. To be specific, the network side may simultaneously perform uplink transmission and downlink transmission at the same moment, the terminal side may only perform either uplink transmission or downlink transmission at the same moment, and uplink transmission and downlink transmission simultaneously performed by the network side at a same moment can only be directed to different terminals. During deployment of the SBFD, semi-static configuration of subband time-frequency locations is used as baseline. However, after a network side configures an uplink subband for a terminal, how the terminal determines a resource available for uplink and/or downlink transmission and performs the uplink and/or downlink transmission is not clear. Consequently, SBFD performance cannot be guaranteed.

### SUMMARY

According to a first aspect, an uplink subband processing method is provided, including:
determining, by a terminal based on an uplink subband configured by a network-side device, a frequency-domain resource available for an SBFD operation within a first bandwidth part BWP in a target SBFD time-domain unit, where
the uplink subband is used for the SBFD operation; and the first BWP is one of BWPs corresponding to a target BWP pair.

According to a second aspect, an uplink subband configuration method is provided, including:
configuring, by a network-side device, an uplink subband for an SBFD operation for a first object, where the uplink subband is used by a terminal to determine a frequency-domain resource available for the SBFD operation within a first BWP in a target SBFD time-domain unit, where
the first object is a target serving cell or a target BWP pair, and the first BWP is one of BWPs corresponding to the target BWP pair.

According to a third aspect, an uplink subband processing apparatus is provided, including:
a determining module, configured to determine, based on an uplink subband configured by a network-side device, a frequency-domain resource available for an SBFD operation within a first BWP in a target SBFD time-domain unit, where
the uplink subband is used for the SBFD operation; and the first BWP is one of BWPs corresponding to a target BWP pair.

According to a fourth aspect, an uplink subband configuration apparatus is provided, including:
a configuration module, configured to configure an uplink subband for an SBFD operation for a first object, where the uplink subband is used by a terminal to determine a frequency-domain resource available for the SBFD operation within a first BWP in a target SBFD time-domain unit, where
the first object is a target serving cell or a target BWP pair, and the first BWP is one of BWPs corresponding to the target BWP pair.

According to a fifth aspect, a terminal is provided. The terminal includes a processor and a memory. The memory stores a program or instructions that can be run on the processor, and when the program or the instructions are executed by the processor, steps of the method according to the first aspect are implemented.

According to a sixth aspect, a terminal is provided, including a processor and a communication interface. The processor is configured to determine, based on an uplink subband configured by a network-side device, a frequency-domain resource available for an SBFD operation within a first BWP in a target SBFD time-domain unit, where the uplink subband is used for the SBFD operation; and the first BWP is one of BWPs corresponding to a target BWP pair.

According to a seventh aspect, a network-side device is provided. The network-side device includes a processor and a memory. The memory stores a program or instructions that can be run on the processor, and when the program or the instructions are executed by the processor, steps of the method according to the second aspect are implemented.

According to an eighth aspect, a network-side device is provided, including a processor and a communication interface. The processor is configured to configure an uplink subband for an SBFD operation for a first object, where the uplink subband is used by a terminal to determine a frequency-domain resource available for the SBFD operation within a first BWP in a target SBFD time-domain unit, where
the first object is a target serving cell or a target BWP pair, and the first BWP is one of BWPs corresponding to the target BWP pair.

According to a ninth aspect, a communication system is provided, including: a terminal and a network-side device. The terminal may be configured to perform steps of the uplink subband processing method according to the first aspect; and the network-side device may be configured to perform steps of the uplink subband configuration method according to the second aspect.

According to a tenth aspect, a readable storage medium is provided. The readable storage medium stores a program or instructions, and when the program or the instructions are executed by a processor, steps of the uplink subband processing method according to the first aspect are implemented, or steps of the uplink subband configuration method according to the second aspect are implemented.

According to an eleventh aspect, a chip is provided. The chip includes a processor and a communication interface. The communication interface is coupled to the processor, and the processor is configured to run a program or instructions, to implement the uplink subband processing method according to the first aspect, or implement the uplink subband configuration method according to the second aspect.

According to a twelfth aspect, a computer program product is provided. The computer program product is stored in a storage medium. The computer program product is executed by at least one processor, to implement the uplink subband processing method according to the first aspect, or implement the uplink subband configuration method according to the second aspect.

### BRIEF DESCRIPTION OF THE DRAWINGS

FIG. 1 is a block diagram of a wireless communication system to which an embodiment of this application is applicable;

FIG. 2 is a flowchart of an uplink subband processing method according to an embodiment of this application;

FIG. 2a is a scenario diagram applicable to an uplink subband processing method according to an embodiment of this application;

FIG. 3 is a flowchart of an uplink subband configuration method according to an embodiment of this application;

FIG. 4 is a diagram of a structure of an uplink subband processing apparatus according to an embodiment of this application;

FIG. 5 is a diagram of a structure of an uplink subband configuration apparatus according to an embodiment of this application;

FIG. 6 is a diagram of a structure of a communication device according to an embodiment of this application;

FIG. 7 is a diagram of a structure of a terminal according to an embodiment of this application; and

FIG. 8 is a diagram of a structure of a network-side device according to an embodiment of this application.

### DETAILED DESCRIPTION

The following clearly describes the technical solutions in embodiments of this application with reference to the accompanying drawings in embodiments of this application. It is clear that the described embodiments are some but not all of embodiments of this application. All other embodiments obtained by a person of ordinary skill in the art based on embodiments of this application fall within the protection scope of this application.

In the specification and claims of this application, the terms “first”, “second”, and the like are intended to distinguish similar objects, but are not necessarily used to describe a specific order or sequence. It should be understood that terms used in such a way are interchangeable in proper circumstances, so that embodiments of this application described herein can be implemented in an order different from the order illustrated or described herein. In addition, the objects distinguished by “first” and “second” are usually one category, and a quantity of objects is not limited. For example, the first object may be one or more. In addition, “and/or” used in this specification and the claims represents at least one of connected objects. The character “/” usually indicates an “or” relationship between associated objects.

It is worth noting that the technology described in embodiments of this application is not limited to being used in a long-term evolution (LTE)/LTE-advanced (LTE-A) system, but may be used in another wireless communication system, for example, a code division multiple access (CDMA) system, a time division multiple access (TDMA) system, a frequency division multiple access (FDMA) system, an orthogonal frequency-division multiple access (OFDMA) system, a single carrier-frequency division multiple access (SC-FDMA) system, and another system. The terms “system” and “network” are often interchangeably used in embodiments of this application, and the technology described may be used for both the system and radio technology mentioned above, and used for another system and radio technology. The following description describes a new radio (NR) system for purposes of example, and the term of NR is used in most of the descriptions below, but these technologies are also applicable to an application beyond an NR system application, for example, a 6th generation (6G) communication system.

FIG. 1 is a block diagram of a wireless communication system to which an embodiment of this application is applicable. The wireless communication system includes a terminal 11 and a network-side device 12. The terminal 11 may be a mobile phone, a tablet computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, an in-vehicle device (VUE), a pedestrian terminal (PUE), a smart home (home devices with a wireless communication function, such as a refrigerator, a television, a washing machine, furniture, or the like), a game console, a personal computer (PC), a teller machine, a self-service machine, or another terminal-side device. The wearable device includes: a smart watch, a smart band, smart headphones, smart glasses, smart jewelry (a smart bangle, a smart bracelet, a smart ring, a smart necklace, a smart ankle bracelet, a smart anklet, and the like), a smart wristband, smart clothing, and the like. It should be noted that, a specific type of the terminal 11 is not limited in embodiments of this application. The network-side device 12 may include an access network device or a core network device. The access network device may alternatively be referred to as a radio access network device, a radio access network (RAN), a radio access network function, or a radio access network element. The access network device may include a base station, a wireless local area network (WLAN) access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission reception point (TRP), or another proper term in the art. As long as the same technical effects are achieved, the base station is not limited to a specific technical term. It should be noted that, only a base station in an NR system is used as an example in embodiments of this application, and a specific type of the base station is not limited.

To better understand the technical solutions in this application, related concepts that may be included in embodiments of this application are described below.

During deployment of a legacy cellular network, frequency division duplex (FDD) or time division duplex (TDD) can be used based on an available frequency spectrum, a service characteristic, and the like. When the FDD is used, uplink transmission and downlink transmission are at different frequency points, do not interfere with each other, and can be simultaneously performed. When the TDD is used, uplink transmission and downlink transmission are at the same frequency point, and are alternately performed in a time-division manner.

A flexible duplex mode has been introduced to utilize limited frequency spectrum resources more flexibly, dynamically adapt to service requirements, and improve resource utilization efficiency and data transmission performance, for example, uplink coverage and a delay. A flexible duplex mode, for example, a non-overlapping subband full duplex (SBFD) is that: full duplex operation at a network side: that is, at the same moment, uplink transmission and downlink transmission can be simultaneously performed at different frequency-domain positions; and to avoid interference between uplink transmission and downlink transmission, a guard band can be reserved between frequency-domain positions corresponding to different transmission directions (corresponding to duplex subbands); and half duplex operation at a terminal side: the half duplex operation at the terminal side is consistent with TDD. In other words, at the same moment, only uplink transmission or downlink transmission is performed, that is, uplink transmission and downlink transmission cannot be simultaneously performed. It may be understood that, in the duplex mode, uplink transmission and downlink transmission at the same moment at the network side can be performed only for different terminals.

In this application, an SBFD time-domain unit (where the time-domain unit is a granularity-based unit in time domain, and may be a slot, a symbol, or the like) is a time-domain unit in which the network side plans to perform an SBFD operation for a specific carrier. The SBFD operation means that full duplex transmission may be performed at the network side, and half duplex transmission may be performed at the UE side. In other words, the network side and the UE side perform uplink and/or downlink transmission based on the rule and frequency-domain resource planning in the SBFD time-domain unit. In a case that the SBFD operation is performed for flexibly utilizing some downlink resources for uplink transmission, to improve performance such as uplink coverage and a delay, the SBFD time-domain unit may be a semi-static downlink (DL) time-domain unit or a semi-static flexible time-domain unit. There is an uplink (UL) subband in the SBFD time-domain unit, and a frequency-domain resource in the UL subband may be available for uplink transmission. The UL subband is a part of the specific carrier in frequency domain, and may be embodied as one to more consecutive resource blocks (RBs) in frequency domain at a given subcarrier spacing. It may be understood that, the semi-static DL time-domain unit or the semi-static flexible time-domain unit herein may be understood as a DL time-domain unit or a flexible time-domain unit determined based on a TDD-UL-DL-ConfigCommon parameter configured by using cell common signaling (for indicating TDD frame structure information for the cell, including a TDD frame period, a quantity of complete downlink/uplink slots included in a single frame period, and a quantity of downlink/uplink symbols additionally included outside the complete downlink/uplink slots, and the like) and/or a TDD-UL-DL-ConfigDedicated parameter configured by UE-specific RRC signaling (for rewriting information configured by the TDD-UL-DL-ConfigCommon parameter for UE).

A bandwidth part (BWP) is a part in a frequency-domain range of a carrier corresponding to a specific serving cell, and may be embodied as a segment of consecutive common resource blocks (CRBs) in frequency domain at a given subcarrier spacing, that is, a set including consecutive CRBs in frequency domain. In a BWP range, each RB may be referred to as a physical resource block (PRB), and a local index starting from 0 is used for PRBs in the BWP range.

The network-side device may configure one to more BWP pairs for the terminal for a specific serving cell (or a component carrier), and usually includes one initial BWP pair plus four dedicated BWP pairs at most. Each BWP pair includes one UL BWP and one DL BWP. For an asymmetric spectrum in Rel-15/16/17 NR, a UL BWP and a DL BWP in a BWP pair correspond to the same carrier, and central frequencies of the UL BWP and the DL BWP are aligned (that is, coincided).

An uplink subband processing method according to an embodiment of this application is described in detail below by using some embodiments and application scenarios thereof with reference to the accompanying drawings.

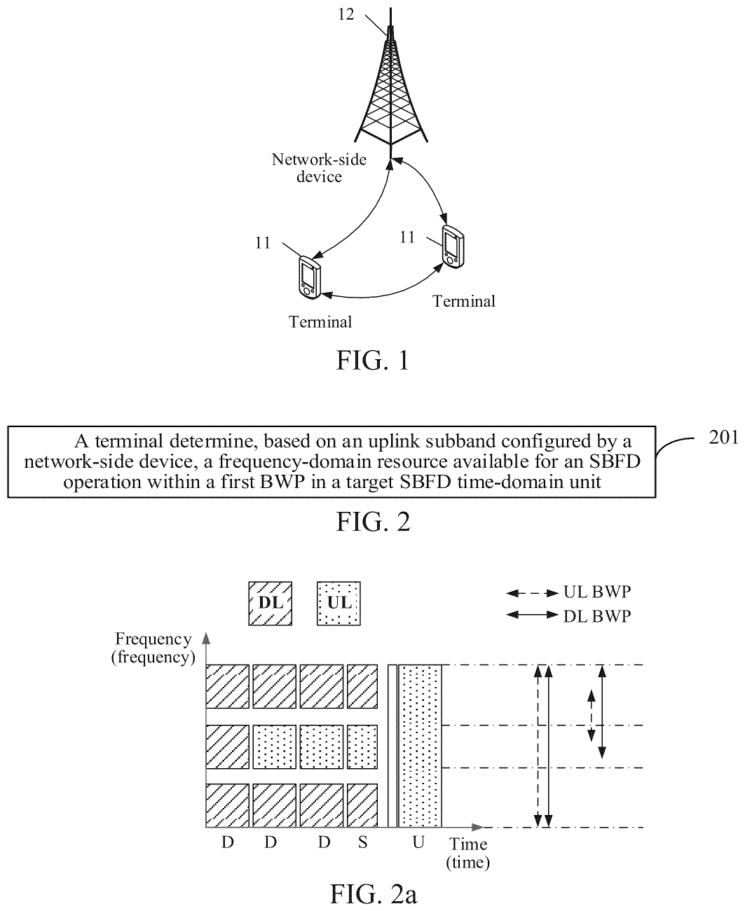

FIG. 2 is a flowchart of an uplink subband processing method according to an embodiment of this application. As shown in FIG. 2, the method includes the following step.

Step 201: A terminal determine, based on an uplink subband configured by a network-side device, a frequency-domain resource available for an SBFD operation within a first BWP in a target SBFD time-domain unit.

The uplink subband is used for the SBFD operation; and the first BWP is one of BWPs corresponding to a target BWP pair. Optionally, BWPs corresponding to the target BWP pair usually include an uplink BWP and a downlink BWP, and the first BWP is the uplink BWP or the downlink BWP in the target BWP pair. The target SBFD time-domain unit may be a time-domain unit supporting subband full duplex. That is, the network-side device may simultaneously perform uplink transmission and downlink transmission at different frequency-domain positions in the time-domain unit. Optionally, the uplink transmission and the downlink transmission are respectively directed to different terminals.

It should be noted that, the network-side device may configure the uplink subband used for the SBFD operation for a target serving cell or a target component carrier (CC). Alternatively, the network-side device may configure the uplink subband used for the SBFD operation for the target BWP pair.

It may be understood that, in a case that the network-side device configures at least one uplink subband for the target serving cell or the target CC of the terminal for one to more SBFD time-domain units, it means that the network-side device expects the terminal to perform the SBFD operation in the target serving cell or the target CC in the one to more SBFD time-domain units. In a case that the network-side device configures the uplink subband used for the SBFD operation for the target BWP pair, the network-side device expects the terminal to perform the SBFD operation on the target BWP pair.

In this embodiment of this application, after obtaining the uplink subband that is configured by the network-side device for the SBFD operation, the terminal needs to determine the frequency-domain resource available for the SBFD operation within the uplink BWP or the downlink BWP in the target SBFD time-domain unit, so that the terminal can perform the SBFD operation on the frequency-domain resource available for the SBFD operation, to ensure performance of performing the SBFD at the terminal side, ensure flexible utilization of a spectrum resource, and improve resource utilization efficiency and performance of uplink transmission.

The target SBFD time-domain unit may be a slot, a symbol, or the like.

Optionally, the method further includes:

the terminal performs, based on the frequency-domain resource, the SBFD operation in the target SBFD time-domain unit.

It may be understood that, after determining the frequency-domain resource available for the SBFD operation within the first BWP in the target SBFD time-domain unit, the terminal may determine whether to apply the SBFD to the first BWP. In a case that the SBFD is applied, the terminal performs the SBFD operation in the target SBFD time-domain unit on the frequency-domain resource, so that the terminal can utilize the limited spectrum resources more flexibly, to improve the resource utilization efficiency.

In this embodiment of this application, in a case that the uplink subband is configured for a target serving cell, the determining a frequency-domain resource available for an SBFD operation within a first BWP in a target SBFD time-domain unit includes:
determining, by the terminal based on a relationship between the first BWP and the uplink subband in frequency domain, the frequency-domain resource available for the SBFD operation within the first BWP in the target SBFD time-domain unit, where the target BWP pair corresponds to the target serving cell.

It may be understood that, the terminal in a connected mode operates on only a single active BWP pair for a specific serving cell at a specific moment. For a specific BWP pair on the target serving cell (for example, an active BWP pair in the target serving cell, that is, the target BWP pair), the terminal can determine, based on the relationship between the first BWP (that is, the uplink BWP or the downlink BWP) corresponding to the BWP pair and the configured uplink subband in frequency domain, whether to apply the SBFD operation on the first BWP and determine a corresponding frequency-domain range in a case that the SBFD operation is applied, so that the terminal can perform the SBFD operation in the determined frequency-domain range, to improve flexibility in spectrum resource utilization.

It should be noted that, in a case that the SBFD operation is mainly performed for improving uplink performance, the frequency-domain range corresponding to the SBFD operation mainly focuses on the frequency-domain range available for uplink transmission in the target SBFD time-domain unit. For the target BWP pair, the terminal may separately determine a relationship between the uplink BWP and the downlink BWP in the target BWP pair and a configured uplink subband in frequency domain, and perform a corresponding operation.

Optionally, the determining, by the terminal based on a relationship between the first BWP and the uplink subband in frequency domain, the frequency-domain resource available for the SBFD operation within the first BWP in the target SBFD time-domain unit includes either one of the following:
in a case that the first BWP is an uplink BWP corresponding to the target BWP pair, determining, by the terminal, a frequency-domain resource available for uplink transmission within the uplink BWP in the target SBFD time-domain unit; or
in a case that the first BWP is a downlink BWP corresponding to the target BWP pair, determining, by the terminal, a frequency-domain resource reserved for uplink transmission within the downlink BWP in the target SBFD time-domain unit.

Further, the determining, by the terminal, a frequency-domain resource available for uplink transmission within the uplink BWP in the target SBFD time-domain unit includes any one of the following:
in a case that the uplink subband is entirely within the uplink BWP, determining, by the terminal, that in the target SBFD time-domain unit, all frequency-domain resources in the uplink subband are available for uplink transmission;
in a case that the uplink subband is partially within the uplink BWP, determining, by the terminal, that in the target SBFD time-domain unit, a frequency-domain resource in the uplink subband that is contained within the uplink BWP is available for uplink transmission; or
in a case that the uplink subband is entirely outside the uplink BWP, determining, by the terminal, that in the target SBFD time-domain unit, no frequency-domain resource in the uplink subband is available for uplink transmission.

Specifically, in a case that the uplink subband is entirely within the uplink BWP, all frequency-domain resources in the uplink subband are available for uplink transmission. In this case, the terminal considers that the terminal applies the SBFD or performs the SBFD operation in the target SBFD time-domain unit. in a case that the uplink subband is partially within the uplink BWP, in the target SBFD time-domain unit, all frequency-domain resources in the uplink subband that are contained within the uplink BWP are available for uplink transmission. in a case that the uplink subband is entirely outside the uplink BWP, in the target SBFD time-domain unit, no frequency-domain resource is available for uplink transmission, or no SBFD operation is applied or performed.

It should be noted that, the relationship between the uplink subband and the uplink BWP (or the downlink BWP described below) in frequency domain may be determined directly based on frequency ranges corresponding to the uplink subband and the uplink BWP, or may be determined based on resource block (RB) ranges corresponding to the uplink subband and the uplink BWP. In a case that determining is performed based on the RB ranges, and given subcarrier spacings are different, the subcarrier spacings need to be first converted into the same subcarrier spacing and then determining is performed.

For example, refer to FIG. 2a. An uplink BWP is used as an example. For a UL BWP shown first on the left in FIG. 2a, an uplink subband is entirely within the UL BWP; and for a second UL BWP shown from the left in FIG. 2a, some resources of the uplink subband overlap the UL BWP.

Optionally, the performing, by the terminal based on the frequency-domain resource, the SBFD operation in the target SBFD time-domain unit includes either one of the following:
in a case that the uplink subband is partially within the uplink BWP, and a quantity of frequency-domain resources in the uplink subband that are contained within the uplink BWP is greater than or equal to a preset first threshold, determining, by the terminal, to perform the SBFD operation in the target SBFD time-domain unit; or
in a case that the uplink subband is partially within the uplink BWP, and a ratio of frequency-domain resources in the uplink subband that are contained within the uplink BWP to frequency-domain resources of a first object is greater than or equal to a preset first ratio, determining, by the terminal, to perform the SBFD operation in the target SBFD time-domain unit, where the first object is any one of the uplink BWP, the uplink subband, and a component carrier.

For example, in a case that the uplink subband configured by the network-side device is partially within the uplink BWP, and the quantity of frequency-domain resources in the uplink subband that are contained within the uplink BWP is greater than or not less than the preset first threshold (or a preset first value), or the ratio of the frequency-domain resources in the uplink subband that are contained within the uplink BWP to the frequency-domain resources of the first object is greater than or not less than the preset first ratio, the terminal considers that the terminal applies the SBFD or performs the SBFD operation in the target SBFD time-domain unit. In this way, the terminal needs to ensure that the frequency-domain resources in the uplink subband that are contained within the uplink BWP satisfy a specific condition, so that the terminal can perform the SBFD operation in the SBFD time-domain unit, to ensure that a quantity of frequency-domain resources available for the SBFD reach a specific number, and ensure SBFD performance.

Optionally, in a case that the uplink subband is configured for a target serving cell, the performing, by the terminal based on the frequency-domain resource, the SBFD operation in the target SBFD time-domain unit includes:
in a case that target uplink transmission is configured or scheduled in the target SBFD time-domain unit, determining, by the terminal, whether the target uplink transmission is valid, where the target uplink transmission corresponds to the target BWP pair.

It should be noted that, after the terminal determines, based on the uplink subband configured by the network-side device, the frequency-domain resource available for the SBFD operation within the first BWP in the target SBFD time-domain unit, in a case that the terminal applies the SBFD or performs the SBFD operation in the target SBFD time-domain unit, for the target uplink transmission configured or scheduled in the target SBFD time-domain unit, the terminal determines whether the target uplink transmission is valid.

The target uplink transmission may include: physical uplink shared channel (PUSCH) transmission, physical uplink control channel (PUCCH) transmission, physical random access channel (PRACH) transmission, sounding reference signal (SRS) transmission, or the like.

Optionally, the determining whether the target uplink transmission is valid includes any one of the following:
in a case that any frequency-domain resource occupied by the target uplink transmission is available for uplink transmission, determining, by the terminal, that the target uplink transmission is valid; or
in a case that at least one of the frequency-domain resources occupied by the target uplink transmission is not available for uplink transmission, determining, by the terminal, that the target uplink transmission is invalid; or in a case that at least one of the frequency-domain resources occupied by the target uplink transmission is available for uplink transmission, determining, by the terminal, that the target uplink transmission is valid.

Optionally, in some embodiments, for the uplink transmission configured or scheduled within the target BWP pair in the SBFD time-domain unit, the terminal expects that all frequency-domain resources occupied by the uplink transmission are available for uplink transmission.
in a case that at least one of the frequency-domain resources occupied by the target uplink transmission is not available for uplink transmission, in a case that the terminal considers that the target uplink transmission is invalid, the terminal actually does not perform the target uplink transmission.

Optionally, in a case that at least one of the frequency-domain resources occupied by the target uplink transmission is not available for uplink transmission, the method further includes:
in a case that the target SBFD time-domain unit is a semi-static flexible time-domain unit, and the target uplink transmission is scheduled uplink transmission, determining, by the terminal, that the target SBFD time-domain unit is reverted to a non-SBFD time-domain unit, and the target uplink transmission is valid, where the terminal does not perform the SBFD operation in the non-SBFD time-domain unit.

It should be noted that, the scheduled uplink transmission may be downlink control information (DCI)-scheduled uplink transmission. For example, in a case that the target SBFD time-domain unit is the semi-static flexible time-domain unit, and the target uplink transmission is the DCI-scheduled uplink transmission, the target SBFD time-domain unit is reverted by the network-side device to the non-SBFD time-domain unit (or may be referred to as a legacy semi-static flexible time-domain unit, that is, a semi-static flexible time-domain unit that performs a corresponding operation according to the Rel-15/16/17 NR specification), and the terminal considers that the network-side device no longer performs the SBFD operation in the semi-static flexible time-domain unit, and the terminal determines that the target uplink transmission is valid, and performs corresponding uplink transmission. Optionally, the terminal considers that the semi-static flexible time-domain unit is further determined as an all uplink time-domain unit based on the DCI-scheduled uplink transmission. In other words, all frequency-domain resources within the frequency-domain range corresponding to the uplink BWP may be available for uplink transmission.

Optionally, in a case that at least one of the frequency-domain resources occupied by the target uplink transmission is available for uplink transmission, the method further includes:
determining, by the terminal, a first set based on a first frequency-domain resource, and performing uplink transmission based on the first set; or
removing, by the terminal, a frequency-domain resource that does not conform to a predefined rule in the first set to obtain a first target subset, and performing uplink transmission based on the first target subset, where
the first frequency-domain resource is any frequency-domain resource that is available for uplink transmission in the frequency-domain resources occupied by the target uplink transmission.

For example, in a case that at least one of the frequency-domain resources occupied by the target uplink transmission is available for uplink transmission, the terminal determines that the target uplink transmission is valid, and performs corresponding uplink transmission based on only a set (that is, the first set) or a subset (that is, the first target subset) including frequency-domain resources available for uplink transmission in the frequency-domain resources occupied by the target uplink transmission.

It should be noted that, the first target subset may be understood as: a subset obtained by the terminal removing the frequency-domain resource that does not conform to the predefined rule in the first set according to the predefined rule after the terminal obtains the first set based on the frequency-domain resources available for uplink transmission in the frequency-domain resources occupied by the target uplink transmission. Optionally, the predefined rule may be a requirement on a resource block group (RBG) granularity, a requirement on discrete fourier transform (DFT) points, or the like.

For example, for the PUSCH frequency domain resource assignment (FDRA) type 0, a frequency-domain resource set actually occupied by PUSCH transmission may need to satisfy the requirement on the RBG granularity (where some RBGs are not allowed to be used). For the PUSCH FDRA type 1, a quantity of RBs actually occupied by PUSCH transmission needs to satisfy the requirement on the DFT points. For example, the quantity of RBs needs to satisfy M_{RB}^{PUSCH}=2^{α}^{₂}·3^{α}^{₃}·5^{α}^{₅}, where α₂, α₃, α₅ are both non-negative integers.

Optionally, in a case that at least one of the frequency-domain resources occupied by the target uplink transmission is available for uplink transmission, the determining, by the terminal, that the target uplink transmission is valid includes any one of the following:
in a case that at least one of the frequency-domain resources occupied by the target uplink transmission is available for uplink transmission, and a quantity of frequency-domain resources available for uplink transmission is greater than or equal to a preset second threshold, determining, by the terminal, that the target uplink transmission is valid;
in a case that at least one of the frequency-domain resources occupied by the target uplink transmission is available for uplink transmission, and a ratio of a quantity of frequency-domain resources available for uplink transmission to a quantity of all frequency-domain resources occupied by the target uplink transmission is greater than or equal to a preset second ratio, determining, by the terminal, that the target uplink transmission is valid;
in a case that at least one of the frequency-domain resources occupied by the target uplink transmission is available for uplink transmission, and a quantity of frequency-domain resources, which are obtained after the terminal removes any frequency-domain resource that does not conform to a predefined rule from the frequency-domain resources available for uplink transmission, is greater than or equal to a preset third threshold, determining, by the terminal, that the target uplink transmission is valid; or
in a case that at least one of the frequency-domain resources occupied by the target uplink transmission is available for uplink transmission, and a ratio of a quantity of frequency-domain resources, which are obtained after the terminal removes any frequency-domain resource that does not conform to a predefined rule from the frequency-domain resources available for uplink transmission, to a quantity of all frequency-domain resources occupied by the target uplink transmission is greater than or equal to a preset third ratio, determining, by the terminal, that the target uplink transmission is valid.

That is, only in a case that the quantity of frequency-domain resources included in the first set or the first target subset satisfies the preset threshold, or the ratio of the quantity of frequency-domain resources included in the first set or the first target subset to the quantity of all frequency-domain resources occupied by the target uplink transmission satisfies the preset ratio, the terminal determines that the target uplink transmission is valid, and performs corresponding uplink transmission.

It should be noted that, in a case that the first set or the first target subset does not include all frequency-domain resources occupied by the target uplink transmission, and the terminal performs the uplink transmission corresponding to the first set or the first target subset, the terminal may use a puncturing manner or a rate matching manner. Puncturing means that: during resource element (RE) mapping, frequency-domain resources that are occupied by the target uplink transmission but are not included in the first set or the first target subset are ignored, and the frequency-domain resources are null or no signal is transmitted during actual transmission. Rate matching means that: during RE mapping, any frequency-domain resource that is occupied by the target uplink transmission but is not included in the first set or the first target subset is avoided.

In this embodiment of this application, in a case that the uplink subband is configured for a target serving cell, and the first BWP is a downlink BWP corresponding to the target BWP pair, the terminal determines a frequency-domain resource reserved for uplink transmission within the downlink BWP in the target SBFD time-domain unit, and performs a corresponding operation.

Optionally, the determining, by the terminal, a frequency-domain resource reserved for uplink transmission within the downlink BWP in the target SBFD time-domain unit includes any one of the following:
in a case that the uplink subband is entirely within the downlink BWP, determining, by the terminal, that in the target SBFD time-domain unit, all frequency-domain resources in the uplink subband are reserved for uplink transmission;
in a case that the uplink subband is partially within the downlink BWP, determining, by the terminal, that in the target SBFD time-domain unit, a frequency-domain resource in the uplink subband that is contained within the downlink BWP is reserved for uplink transmission; or
in a case that the uplink subband is entirely outside the downlink BWP, determining, by the terminal, that in the target SBFD time-domain unit, no frequency-domain resource in the downlink BWP is reserved for uplink transmission.

For example, refer to FIG. 2a. A downlink BWP is used as an example. For a DL BWP shown first on the left in FIG. 2a, an uplink subband is entirely within the DL BWP; and for a second DL BWP shown from the left in FIG. 2a, some resources of the uplink subband overlap the DL BWP. In other words, the uplink subband is partially within the DL BWP.

It should be noted that, in a case that the uplink subband is entirely outside the downlink BWP, existence of the uplink subband does not affect downlink transmission of the terminal in the downlink BWP.

In addition, in a case that the uplink subband is partially within the downlink BWP, in the target SBFD time-domain unit, a frequency-domain resource in the uplink subband that is contained within the downlink BWP is reserved for uplink transmission. Optionally, in this case, the terminal does not expect the uplink subband to be entirely within the downlink BWP. In this case, downlink transmission in the downlink BWP may be seriously affected.

Further, the performing, by the terminal based on the frequency-domain resource, the SBFD operation in the target SBFD time-domain unit includes:
in a case that target downlink transmission is configured or scheduled in the target SBFD time-domain unit, determining, by the terminal, whether the target downlink transmission is valid, where the target downlink transmission corresponds to the target BWP pair.

That is, in a case that the terminal applies the SBFD or performs the SBFD operation in the target serving cell in the target SBFD time-domain unit, for the target downlink transmission configured or scheduled within the target BWP pair in the target SBFD time-domain unit, the terminal can determine whether the target downlink transmission is valid. The target downlink transmission includes: physical downlink control channel (PDCCH) transmission, physical downlink shared channel (PDSCH) transmission, channel state information reference signal (CSI-RS) transmission, or the like.

Optionally, the determining whether the target downlink transmission is valid includes any one of the following:
in a case that any frequency-domain resource occupied by the target downlink transmission is not reserved for uplink transmission, determining, by the terminal, that the target downlink transmission is valid;
in a case that at least one of the frequency-domain resources occupied by the target downlink transmission is reserved for uplink transmission, determining, by the terminal, that the target downlink transmission is invalid; or in a case that at least one of the frequency-domain resources occupied by the target downlink transmission is not reserved for uplink transmission, determining, by the terminal, that the target downlink transmission is valid.
in a case that any frequency-domain resource occupied by the target downlink transmission is not reserved for uplink transmission, the terminal determines that the target downlink transmission is valid, and performs corresponding downlink transmission (that is, the terminal performs downlink reception). Optionally, the method further includes:
for the target downlink transmission configured or scheduled within the target BWP pair in the target SBFD time-domain unit, expecting, by the terminal, that all frequency-domain resources occupied by the target downlink transmission are not reserved for uplink transmission.

In addition, in a case that at least one of the frequency-domain resources occupied by the target downlink transmission is reserved for uplink transmission, the terminal determines that the target downlink transmission is invalid, and the terminal actually does not perform the target downlink transmission. Optionally, in this case, the method further includes:
in a case that the target SBFD time-domain unit is a semi-static flexible time-domain unit or a semi-static downlink time-domain unit, and the target downlink transmission is scheduled downlink transmission, determining, by the terminal, that the target SBFD time-domain unit is reverted to a non-SBFD time-domain unit, and the target downlink transmission is valid, where the terminal does not perform the SBFD operation in the non-SBFD time-domain unit.

That is, in a case that the target SBFD time-domain unit is the semi-static flexible time-domain unit or the semi-static DL time-domain unit, and the target downlink transmission is the scheduled downlink transmission (that is, the DCI-scheduled downlink transmission), the target SBFD time-domain unit is reverted by the network-side device to the non-SBFD time-domain unit (or may be referred to as a legacy semi-static flexible/DL time-domain unit, that is, the terminal considers that the network-side device no longer performs the SBFD operation in the semi-static flexible/DL time-domain unit, and only performs a corresponding operation of the semi-static flexible/DL time-domain unit according to an existing specification such as the Rel-15/16/17 NR specification), and the terminal determines that the target downlink transmission is valid, and performs the corresponding downlink transmission. In this way, the terminal can utilize the frequency-domain resource more flexibly. Optionally, in a case that the target SBFD time-domain unit is a semi-static flexible time-domain unit, the terminal considers that the semi-static flexible time-domain unit is further determined as an all downlink time-domain unit based on the DCI-scheduled downlink transmission. In other words, all frequency-domain resources within the frequency-domain range corresponding to the downlink BWP can be used for downlink transmission.

Optionally, in a case that at least one of the frequency-domain resources occupied by the target downlink transmission is not reserved for uplink transmission, the method further includes:
determining, by the terminal, a second set based on a second frequency-domain resource, and performing downlink transmission based on the second set; or
removing, by the terminal, a frequency-domain resource that does not conform to a predefined rule in the second set to obtain a second target subset, and performing downlink transmission based on the second target subset, where
the second frequency-domain resource is any frequency-domain resource that is not reserved for uplink transmission in the frequency-domain resources occupied by the downlink transmission.

For example, in a case that at least one of the frequency-domain resources occupied by the target downlink transmission is not reserved for uplink transmission, the terminal determines that the target downlink transmission is valid, and performs corresponding downlink transmission based on only the second set or the second target subset including frequency-domain resources that are not reserved for uplink transmission in the frequency-domain resources occupied by the target downlink transmission.

It should be noted that, the second target subset may be understood as: a subset obtained by the terminal removing the frequency-domain resource that does not conform to the predefined rule in the second set according to the predefined rule after the terminal obtains the second set based on the frequency-domain resources that are not reserved for uplink transmission in the frequency-domain resources occupied by the target downlink transmission. For example, for the PDSCH FDRA type 0, the predefined rule may be a requirement on an RBG granularity (where a partial RBG is not allowed to be used) that needs to be satisfied by a frequency-domain resource set actually occupied by the PDSCH transmission. Certainly, the predefined rule may alternatively be in another possible condition. This is not specifically listed herein.

Optionally, in a case that at least one of the frequency-domain resources occupied by the target downlink transmission is not reserved for uplink transmission, the determining, by the terminal, that the target downlink transmission is valid includes any one of the following:
in a case that at least one of the frequency-domain resources occupied by the target downlink transmission is not reserved for uplink transmission, and a quantity of frequency-domain resources not reserved for uplink transmission is greater than or equal to a preset fourth threshold, determining, by the terminal, that the target downlink transmission is valid;
in a case that at least one of the frequency-domain resources occupied by the target downlink transmission is not reserved for uplink transmission, and a ratio of a quantity of frequency-domain resources not reserved for uplink transmission to a quantity of all frequency-domain resources occupied by the target downlink transmission is greater than or equal to a preset third ratio, determining, by the terminal, that the target downlink transmission is valid;
in a case that at least one of the frequency-domain resources occupied by the target downlink transmission is not reserved for uplink transmission, and a quantity of frequency-domain resources, which are obtained after the terminal removes any frequency-domain resource that does not conform to a predefined rule from the frequency-domain resources that are not reserved for uplink transmission, is greater than or equal to a preset fourth threshold, determining, by the terminal, that the target downlink transmission is valid; or
in a case that at least one of the frequency-domain resources occupied by the target downlink transmission is not reserved for uplink transmission, and a ratio of a quantity of frequency-domain resources, which are obtained after the terminal removes any frequency-domain resource that does not conform to a predefined rule from the frequency-domain resources that are not reserved for uplink transmission, to a quantity of all frequency-domain resources occupied by the target downlink transmission is greater than or equal to a preset fourth ratio, determining, by the terminal, that the target downlink transmission is valid.

That is, only in a case that the quantity of frequency-domain resources included in the second set or the second target subset satisfies the preset threshold (or a preset value), or the ratio of the quantity of frequency-domain resources included in the second set or the second target subset to the quantity of all frequency-domain resources occupied by the target downlink transmission satisfies the preset ratio, the terminal determines that the target downlink transmission is valid, and performs corresponding downlink transmission.

It should be noted that, in a case that the second set or the second target subset does not include all frequency-domain resources occupied by the target downlink transmission, and the terminal performs the downlink transmission corresponding to the second set or the second target subset, the terminal may use a puncturing manner or a rate matching manner. The puncturing manner means that: during RE mapping, frequency-domain resources that are occupied by the target uplink transmission but are not included in the first set or the first target subset are ignored, and the frequency-domain resources are null or no signal is transmitted during actual transmission. The rate matching manner means that: during RE mapping, any frequency-domain resource that is occupied by the target uplink transmission but is not included in the first set or the first target subset is avoided.

In this embodiment of this application, in a case that the uplink subband is configured for a target serving cell, the determining, by a terminal based on an uplink subband configured by a network-side device, a frequency-domain resource available for an SBFD operation within a first bandwidth part BWP in a target SBFD time-domain unit includes:
in a case that the network-side device configures the terminal to perform the SBFD operation in the target BWP pair, determining, by the terminal based on a relationship between the first BWP and the uplink subband in frequency domain, the frequency-domain resource available for the SBFD operation within the first BWP in the target SBFD time-domain unit.

Optionally, in a case that the first BWP is an uplink BWP, a relationship between the uplink BWP and the uplink subband in frequency domain includes either one of the following:
the uplink subband is entirely within the uplink BWP; or
the uplink subband is partially within the uplink BWP.

It should be noted that, in this manner, for the target BWP pair in which the relationship between the uplink BWP and the uplink subband in frequency domain satisfies any one of the foregoing conditions, the network-side device may explicitly or implicitly configure whether the terminal applies the SBFD in the target BWP pair. For the target BWP pair to which the SBFD is configured, the terminal determines, based on the relationship between the uplink BWP or the downlink BWP in the target BWP pair and the uplink subband in frequency domain, the frequency-domain resource available for the SBFD operation within the uplink BWP or the downlink BWP in the target SBFD time-domain unit, and performs the corresponding SBFD operation. For details, refer to the descriptions in the foregoing embodiments. Optionally, in a case that the uplink subband is partially within the uplink BWP corresponding to the target BWP pair, only in a case that the quantity of frequency-domain resources in the uplink subband that are contained within the uplink BWP satisfies a requirement corresponding to the preset first threshold or the preset first ratio, the network-side device may explicitly or implicitly configure whether the terminal applies the SBFD to the target BWP pair, or configure the terminal to apply the SBFD to the target BWP pair.

It may be understood that, for a BWP pair to which the SBFD is applied, the terminal does not expect that the uplink subband is entirely outside the UL BWP and/or the DL BWP, or the terminal does not expect that the uplink subband is partially within the UL BWP and/or the DL BWP, or the terminal does not expect that the uplink subband is partially within the UL BWP and/or the DL BWP and the quantity or the ratio of frequency-domain resources in the uplink subband that are contained within the uplink BWP and/or the DL BWP does not satisfy the preset threshold requirement. For the preset threshold requirement, refer to the descriptions of the foregoing preset first threshold and the preset first ratio. Details are not described herein again.

In this embodiment of this application, in a case that the uplink subband is configured for a target serving cell, the uplink subband includes at least one of the following parameters:
a preset subcarrier spacing;
a starting common resource block (CRB) index of the uplink subband; and
a quantity of CRBs included in the uplink subband.

It should be noted that, the starting CRB index of the uplink subband may be CRB 0, or a first available CRB of the target serving cell or the target component carrier for the preset subcarrier spacing.

Optionally, the preset subcarrier spacing is determined based on at least one of the following:
reusing a subcarrier spacing parameter in a time division duplex uplink and downlink configuration parameter;
independently configured by the network-side device; and
reusing a subcarrier spacing parameter of a second BWP of the terminal.

The second BWP may be an initial BWP, a first active BWP, an active BWP, or the like, and the second BWP may be an uplink BWP and/or a downlink BWP.

Optionally, in a case that the preset subcarrier spacing is independently configured by the network-side device, a value of an index corresponding to the preset subcarrier spacing satisfies any one of the following:
the value is the same as a value of an index corresponding to a reference subcarrier spacing in a time division duplex uplink and downlink configuration parameter (referenceSubcarrierSpacing in TDD-UL-DL-ConfigCommon);
the value is less than or equal to a value of an index corresponding to a reference subcarrier spacing in a time division duplex uplink and downlink configuration parameter;
the value is less than or equal to a value of an index corresponding to a subcarrier spacing corresponding to an uplink BWP or a downlink BWP in any BWP pair configured for a component carrier or a serving cell; or
the value is the same as a value of an index of a subcarrier spacing of the second BWP of the terminal.

In this embodiment of this application, the uplink subband may alternatively be configured by the network-side device for the target BWP pair. For example, for the target BWP pair on which the SBFD operation is expected to be performed, the network-side device may configure the uplink subband for the target BWP pair. In a case that the terminal uses the target BWP pair as an active BWP pair, the terminal may perform the SBFD operation based on the configured uplink subband.

Optionally, in a case that the uplink subband is configured for the target BWP pair, the configuration of the uplink subband satisfies either one of the following:
configuring the uplink subband in an uplink BWP corresponding to the target BWP pair; or
configuring the uplink subband in a downlink BWP corresponding to the target BWP pair.

Optionally, in a case that the uplink subband is configured in a target BWP corresponding to the target BWP pair, a frequency-domain range of the uplink subband is entirely within a frequency-domain range corresponding to the target BWP, and the target BWP is the uplink BWP or the downlink BWP.

For example, in a case that the uplink subband is configured within the uplink BWP corresponding to the target BWP pair, a frequency-domain range of the uplink subband is entirely within a frequency-domain range corresponding to the uplink BWP. In this case, the uplink subband is configured as a physical resource block (PRB) range, and a subcarrier spacing (SCS) corresponding to the PRB range is a subcarrier spacing corresponding to the uplink BWP. The PRB is an RB within the uplink BWP.

Optionally, the PRB range includes a starting PRB index and a quantity of PRBs contained in the PRB range, which are configured by the network-side device.

Further, in a case that the uplink subband is configured within the uplink BWP corresponding to the target BWP pair, all frequency-domain resources in the uplink subband are available for uplink transmission.

Optionally, in a case that the uplink subband is configured within the uplink BWP corresponding to the target BWP pair, and the first BWP is the downlink BWP, determining, by the terminal based on a relationship between the first BWP and the uplink subband in frequency domain, the frequency-domain resource available for the SBFD operation in the target SBFD time-domain unit includes any one of the following:
in a case that the uplink subband is entirely within the downlink BWP, determining, by the terminal, that in the target SBFD time-domain unit, all frequency-domain resources in the uplink subband are reserved for uplink transmission;
in a case that the uplink subband is partially within the downlink BWP, determining, by the terminal, that in the target SBFD time-domain unit, a frequency-domain resource in the uplink subband that is contained within the downlink BWP is reserved for uplink transmission; or
in a case that the uplink subband is entirely outside the downlink BWP, determining, by the terminal, that in the target SBFD time-domain unit, no frequency-domain resource in the downlink BWP is reserved for uplink transmission.

That is, in a case that the network-side device configures the uplink subband that is contained within the uplink BWP in the target BWP pair, for the downlink BWP, in the target SBFD time-domain unit, the terminal can determine the relationship between the downlink BWP and the configured uplink subband in frequency domain (that is, the foregoing three cases), and perform corresponding operations based on different frequency-domain relationships.

Optionally, in a case that the uplink subband is configured within the uplink BWP corresponding to the target BWP pair, expecting, by the terminal, that the uplink subband is entirely within the downlink BWP. That is, the terminal expects that the network-side always divides an uplink subband in the downlink BWP to perform the SBFD operation, to ensure flexible utilization of the frequency-domain resource.

Optionally, in a case that the uplink subband is configured within the downlink BWP corresponding to the target BWP pair, generally, a frequency-domain range of the configured uplink subband is entirely included in a frequency-domain range corresponding to the downlink BWP. In this case, the uplink subband may be configured as a PRB range, an SCS corresponding to the PRB range is directly an SCS corresponding to the downlink BWP, and the network side configures a starting PRB index and a quantity of PRBs contained in the PRB range that correspond to the PRB range. The PRB is an RB in the downlink BWP.

Further, in a case that the uplink subband is configured within the downlink BWP corresponding to the target BWP pair, and the first BWP is the uplink BWP, determining, by the terminal based on a relationship between the first BWP and the uplink subband in frequency domain, the frequency-domain resource available for the SBFD operation in the target SBFD time-domain unit includes any one of the following:
in a case that the uplink subband is entirely within the uplink BWP, determining, by the terminal, that in the target SBFD time-domain unit, all frequency-domain resources in the uplink subband are available for uplink transmission;
in a case that the uplink subband is partially within the uplink BWP, determining, by the terminal, that in the target SBFD time-domain unit, a frequency-domain resource in the uplink subband that is contained within the uplink BWP is available for uplink transmission; or
in a case that the uplink subband is entirely outside the uplink BWP, determining, by the terminal, that in the target SBFD time-domain unit, no frequency-domain resource in the uplink subband is available for uplink transmission.

That is, in a case that the network-side device configures the uplink subband in the downlink BWP in the target BWP pair, for the uplink BWP, in the target SBFD time-domain unit, the terminal can determine the relationship between the uplink BWP and the configured uplink subband in frequency domain (that is, the foregoing three cases), and perform corresponding operations based on different frequency-domain relationships.

Optionally, in a case that the uplink subband is configured within the downlink BWP corresponding to the target BWP pair, the terminal always expects that the uplink subband is entirely within the uplink BWP, that is, the uplink subband divided by the network-side device in the downlink BWP always completely falls within the uplink BWP range, and can be completely used for resource assignment and uplink transmission in an uplink direction. Alternatively, the terminal does not expect that the uplink subband is entirely outside the uplink BWP. In this case, the uplink subband divided by the network-side device in the downlink BWP does not fall within the uplink BWP range, and the terminal cannot utilize resources in the uplink subband to perform uplink transmission.

In addition, in a case that the uplink subband is configured within the downlink BWP corresponding to the target BWP pair, and the first BWP is the downlink BWP, all frequency-domain resources in the uplink subband are reserved for uplink transmission.

In this embodiment of this application, for different manners by the network-side device to configure the uplink subband used for the SBFD operation, the terminal can determine, for the configuration of the uplink subband, the frequency-domain resource available for the SBFD operation within the uplink BWP and/or the downlink BWP in the target SBFD time-domain unit, and perform the SBFD operation in the target SBFD time-domain unit based on the frequency-domain resource, to ensure performance of the SBFD, ensure flexible utilization of the frequency-domain resource by the terminal, and improve resource utilization efficiency, to dynamically adapt to service requirements.

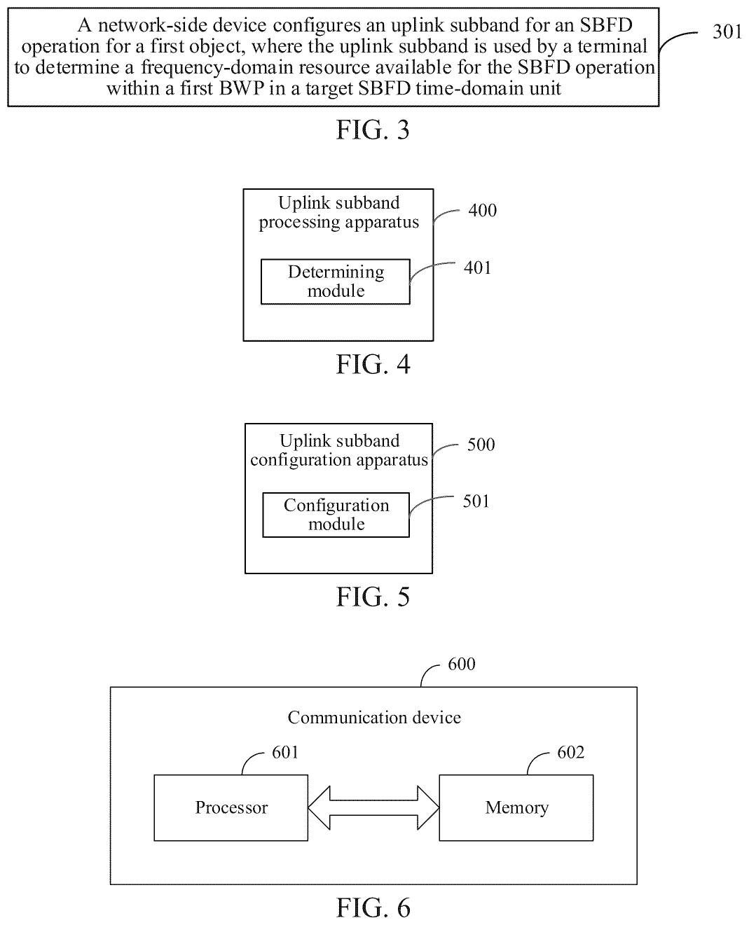

FIG. 3 is a flowchart of an uplink subband configuration method according to an embodiment of this application. As shown in FIG. 3, the method includes the following step.

Step 301: A network-side device configures an uplink subband for an SBFD operation for a first object, where the uplink subband is used by a terminal to determine a frequency-domain resource available for the SBFD operation within a first BWP in a target SBFD time-domain unit, where
the first object is a target serving cell or a target BWP pair, and the first BWP is one of BWPs corresponding to the target BWP pair.

For example, the network-side device configures the uplink subband used for the SBFD operation for the target serving cell. Alternatively, the network-side device configures the uplink subband used for the SBFD operation for the target BWP pair.

Optionally, in a case that the target BWP pair is a BWP pair used by the terminal to expect to perform the SBFD operation, the configuring, by a network-side device, an uplink subband for an SBFD operation for a first object includes:
configuring, by the network-side device, the uplink subband used for the SBFD operation for the target BWP pair.

Further, the configuring, by the network-side device, the uplink subband used for the SBFD operation for the target BWP pair includes either one of the following:
configuring, by the network-side device, the uplink subband used for the SBFD operation within an uplink BWP corresponding to the target BWP pair; or
configuring, by the network-side device, the uplink subband used for the SBFD operation within a downlink BWP corresponding to the target BWP pair.

Optionally, in a case that a frequency-domain range of the configured uplink subband is entirely within a frequency-domain range corresponding to a target BWP, the uplink subband is configured as a PRB range, and a subcarrier spacing corresponding to the PRB range is a subcarrier spacing corresponding to the target BWP; and the target BWP is the uplink BWP or the downlink BWP.

In this case, the method further includes:
configuring, by the network-side device, a starting PRB index and a quantity of PRBs contained in the PRB range, which correspond to the PRB range.

In this embodiment of this application, in a case that the network-side device configures the uplink subband for the target serving cell, the method further includes:
configuring, by the network-side device, at least one of the following for the uplink subband:
a preset subcarrier spacing;
a CRB index of the uplink subband; and
a quantity of CRBs included in the uplink subband.

In a case that the configuration of the uplink subband includes the preset subcarrier spacing, the method further includes:
determining, by the network-side device, the preset subcarrier spacing based on at least one of the following:
directly reusing a subcarrier spacing parameter (referenceSubcarrierSpacing in TDD-UL-DL-ConfigCommon) in a time division duplex uplink and downlink configuration parameter;
independently configured; and
directly reusing a subcarrier spacing parameter of a second BWP of the terminal.

Optionally, the second BWP may be an initial BWP, a first active BWP, an active BWP the like, and the second BWP may be an uplink BWP and/or a downlink BWP.

It should be noted that, in a case that the network-side device does not perform independent configuration, the preset subcarrier spacing adopts either one of the following by default:
a referenceSubcarrierSpacing parameter in TDD-UL-DL-ConfigCommon; or
a subcarrier spacing parameter of the second BWP of the terminal.

Further, in a case that the preset subcarrier spacing is independently configured by the network-side device, a value of an index corresponding to the preset subcarrier spacing satisfies any one of the following:
the value is the same as a value of an index corresponding to the referenceSubcarrierSpacing in TDD-UL-DL-ConfigCommon;
the value is less than or equal to a value of an index corresponding to the referenceSubcarrierSpacing in TDD-UL-DL-ConfigCommon;
the value is less than or equal to a value of an index corresponding to a subcarrier spacing corresponding to an uplink BWP or a downlink BWP in any BWP pair configured for a component carrier or a serving cell; or
the value is the same as a value of an index of a subcarrier spacing of the second BWP of the terminal.

It should be noted that, for a related concept and a specific process related to the uplink subband configuration method performed by the network-side device according to this embodiment of this application, refer to the descriptions in the foregoing terminal-side embodiment. For example, the network-side device may determine, in the same manner as that of the terminal, the frequency-domain resource available for the SBFD operation within a first BWP in the target SBFD time-domain unit. To avoid repetition, details are not described herein again.

In this embodiment of this application, the network-side device can configure the uplink subband for the SBFD operation based on different configuration manners, so that the terminal can determine, for the configuration of the uplink subband, the frequency-domain resource available for the SBFD operation within the uplink BWP and/or the downlink BWP in the target SBFD time-domain unit, and perform the SBFD operation in the target SBFD time-domain unit based on the frequency-domain resource, to ensure performance of the SBFD, ensure flexible utilization of the frequency-domain resource by the terminal, and improve resource utilization efficiency, to dynamically adapt to service requirements.

The uplink subband processing method according to embodiments of this application may be performed by an uplink subband processing apparatus. In embodiments of this application, the uplink subband processing apparatus provided in embodiments of this application is described by using an example in which the uplink subband processing apparatus performs the uplink subband processing method.

FIG. 4 is a diagram of a structure of an uplink subband processing apparatus according to an embodiment of this application. As shown in FIG. 4, the uplink subband processing apparatus 400 includes:
a determining module 401, configured to determine, based on an uplink subband configured by a network-side device, a frequency-domain resource available for an SBFD operation within a first BWP in a target SBFD time-domain unit, where
the uplink subband is used for the SBFD operation; and the first BWP is one of BWPs corresponding to a target BWP pair.

Optionally, the apparatus further includes:
an execution module, configured to perform, based on the frequency-domain resource, the SBFD operation in the target SBFD time-domain unit.

Optionally, in a case that the uplink subband is configured for a target serving cell, the determining module 401 is further configured to:
determine, based on a relationship between the first BWP and the uplink subband in frequency domain, the frequency-domain resource available for the SBFD operation within the first BWP in the target SBFD time-domain unit, where
the target BWP pair corresponds to the target serving cell.

Optionally, the determining module 401 is further configured to perform either one of the following:
in a case that the first BWP is an uplink BWP corresponding to the target BWP pair, determine a frequency-domain resource available for uplink transmission within the uplink BWP in the target SBFD time-domain unit; or
in a case that the first BWP is a downlink BWP corresponding to the target BWP pair, determine a frequency-domain resource reserved for uplink transmission within the downlink BWP in the target SBFD time-domain unit.

Optionally, the determining module 401 is further configured to perform any one of the following:
in a case that the uplink subband is entirely within the uplink BWP, determine that in the target SBFD time-domain unit, all frequency-domain resources in the uplink subband are available for uplink transmission;
in a case that the uplink subband is partially within the uplink BWP, determine that in the target SBFD time-domain unit, a frequency-domain resource in the uplink subband that is contained within the uplink BWP is available for uplink transmission; or
in a case that the uplink subband is entirely outside the uplink BWP, determine that in the target SBFD time-domain unit, no frequency-domain resource in the uplink subband is available for uplink transmission.

Optionally, the execution module is further configured to perform either one of the following:
in a case that the uplink subband is partially within the uplink BWP, and a quantity of frequency-domain resources in the uplink subband that are contained within the uplink BWP is greater than or equal to a preset first threshold, determine to perform the SBFD operation in the target SBFD time-domain unit; or
in a case that the uplink subband is partially within the uplink BWP, and a ratio of a quantity of frequency-domain resources in the uplink subband that are contained within the uplink BWP to a quantity of frequency-domain resources of a first object is greater than or equal to a preset first ratio, determine to perform the SBFD operation in the target SBFD time-domain unit, where the first object is any one of the uplink BWP, the uplink subband, and a component carrier.

Optionally, the execution module is further configured to:
in a case that target uplink transmission is configured or scheduled in the target SBFD time-domain unit, determine whether the target uplink transmission is valid, where the target uplink transmission corresponds to the target BWP pair.

Optionally, the execution module is further configured to perform any one of the following:
in a case that any frequency-domain resource occupied by the target uplink transmission is available for uplink transmission, determine that the target uplink transmission is valid;
in a case that at least one of the frequency-domain resources occupied by the target uplink transmission is not available for uplink transmission, determine that the target uplink transmission is invalid; or in a case that at least one of the frequency-domain resources occupied by the target uplink transmission is available for uplink transmission, determine that the target uplink transmission is valid.

Optionally, in a case that at least one of the frequency-domain resources occupied by the target uplink transmission is not available for uplink transmission, the execution module is further configured to:
in a case that the target SBFD time-domain unit is a semi-static flexible time-domain unit, and the target uplink transmission is scheduled uplink transmission, determine that the target SBFD time-domain unit is reverted to a non-SBFD time-domain unit, and the target uplink transmission is valid, where

the apparatus does not perform the SBFD operation in the non-SBFD time-domain unit.

Optionally, in a case that at least one of the frequency-domain resources occupied by the target uplink transmission is available for uplink transmission, the execution module is further configured to:
determine a first set based on a first frequency-domain resource, and perform uplink transmission based on the first set; or
remove a frequency-domain resource that does not conform to a predefined rule in the first set to obtain a first target subset, and perform uplink transmission based on the first target subset, where
the first frequency-domain resource is any frequency-domain resource that is available for uplink transmission in the frequency-domain resources occupied by the target uplink transmission.

Optionally, in a case that at least one of the frequency-domain resources occupied by the target uplink transmission is available for uplink transmission, the execution module is further configured to perform any one of the following:
in a case that at least one of the frequency-domain resources occupied by the target uplink transmission is available for uplink transmission, and a quantity of frequency-domain resources available for uplink transmission is greater than or equal to a preset second threshold, determine that the target uplink transmission is valid;
in a case that at least one of the frequency-domain resources occupied by the target uplink transmission is available for uplink transmission, and a ratio of a quantity of frequency-domain resources available for uplink transmission to a quantity of all frequency-domain resources occupied by the target uplink transmission is greater than or equal to a preset second ratio, determine that the target uplink transmission is valid;
in a case that at least one of the frequency-domain resources occupied by the target uplink transmission is available for uplink transmission, and a quantity of frequency-domain resources, which are obtained after removing any frequency-domain resource that does not conform to a predefined rule from the frequency-domain resources available for uplink transmission, is greater than or equal to a preset third threshold, determine that the target uplink transmission is valid; or
in a case that at least one of the frequency-domain resources occupied by the target uplink transmission is available for uplink transmission, and a ratio of a quantity of frequency-domain resources, which are obtained after removing any frequency-domain resource does not conform to a predefined rule from the frequency-domain resources available for uplink transmission, to a quantity of all frequency-domain resources occupied by the target uplink transmission is greater than or equal to a preset third ratio, determine that the target uplink transmission is valid.

Optionally, the determining module 401 is further configured to perform any one of the following:
in a case that the uplink subband is entirely within the downlink BWP, determine that in the target SBFD time-domain unit, all frequency-domain resources in the uplink subband are reserved for uplink transmission;
in a case that the uplink subband is partially within the downlink BWP, determine that in the target SBFD time-domain unit, a frequency-domain resource in the uplink subband that is contained within the downlink BWP is reserved for uplink transmission; or
in a case that the uplink subband is entirely outside the downlink BWP, determine that in the target SBFD time-domain unit, no frequency-domain resource in the downlink BWP is reserved for uplink transmission.

Optionally, the execution module is further configured to:
in a case that target downlink transmission is configured or scheduled in the target SBFD time-domain unit, determine whether the target downlink transmission is valid, where the target downlink transmission corresponds to the target BWP pair.

Optionally, the execution module is further configured to perform at least one of the following:
in a case that any frequency-domain resource occupied by the target downlink transmission is not reserved for uplink transmission, determine that the target downlink transmission is valid;
in a case that at least one of the frequency-domain resources occupied by the target downlink transmission is reserved for uplink transmission, determine that the target downlink transmission is invalid; or in a case that at least one of the frequency-domain resources occupied by the target downlink transmission is not reserved for uplink transmission, determine that the target downlink transmission is valid.

Optionally, in a case that any frequency-domain resource occupied by the target downlink transmission is not reserved for uplink transmission, the execution module is further configured to:
for the target downlink transmission configured or scheduled within the target BWP pair in the target SBFD time-domain unit, expect that all frequency-domain resources occupied by the target downlink transmission are not reserved for uplink transmission.

Optionally, in a case that at least one of the frequency-domain resources occupied by the target downlink transmission is reserved for uplink transmission, the execution module is further configured to:
in a case that the target SBFD time-domain unit is a semi-static flexible time-domain unit, and the target downlink transmission is scheduled downlink transmission, determine that the target SBFD time-domain unit is reverted to a non-SBFD time-domain unit, and the target downlink transmission is valid, where
the apparatus does not perform the SBFD operation in the non-SBFD time-domain unit.

Optionally, in a case that at least one of the frequency-domain resources occupied by the target downlink transmission is not reserved for uplink transmission, the execution module is further configured to:
determine a second set based on a second frequency-domain resource, and perform downlink transmission based on the second set; or
remove a frequency-domain resource that does not conform to a predefined rule in the second set to obtain a second target subset, and perform downlink transmission based on the second target subset, where
the second frequency-domain resource is any frequency-domain resource that is not reserved for uplink transmission in the frequency-domain resources occupied by the downlink transmission.

Optionally, in a case that at least one of the frequency-domain resources occupied by the target downlink transmission is not reserved for uplink transmission, the execution module is further configured to perform any one of the following:
in a case that at least one of the frequency-domain resources occupied by the target downlink transmission is not reserved for uplink transmission, and a quantity of frequency-domain resources not reserved for uplink transmission is greater than or equal to a preset fourth threshold, determine that the target downlink transmission is valid;
in a case that at least one of the frequency-domain resources occupied by the target downlink transmission is not reserved for uplink transmission, and a ratio of a quantity of frequency-domain resources not reserved for uplink transmission to a quantity of all frequency-domain resources occupied by the target downlink transmission is greater than or equal to a preset third ratio, determine that the target downlink transmission is valid;
in a case that at least one of the frequency-domain resources occupied by the target downlink transmission is not reserved for uplink transmission, and a quantity of frequency-domain resources, which are obtained after removing any frequency-domain resource that does not conform to a predefined rule from the frequency-domain resources that are not reserved for uplink transmission, is greater than or equal to a preset fourth threshold, determine that the target downlink transmission is valid; or
in a case that at least one of the frequency-domain resources occupied by the target downlink transmission is not reserved for uplink transmission, and a ratio of a quantity of frequency-domain resources, which are obtained after removing any frequency-domain resource that does not conform to a predefined rule from the frequency-domain resources that are not reserved for uplink transmission, to a quantity of all frequency-domain resources occupied by the target downlink transmission is greater than or equal to a preset fourth ratio, determine that the target downlink transmission is valid.

Optionally, in a case that the uplink subband is configured for a target serving cell, the determining module 401 is further configured to:
in a case that the network-side device configures the apparatus to perform the SBFD operation in the target BWP pair, determine, based on a relationship between the first BWP and the uplink subband in frequency domain, the frequency-domain resource available for the SBFD operation within the first BWP in the target SBFD time-domain unit.

Optionally, in a case that the first BWP is an uplink BWP, a relationship between the uplink BWP and the uplink subband in frequency domain includes either one of the following:
the uplink subband is entirely within the uplink BWP; or
the uplink subband is partially within the uplink BWP.

Optionally, in a case that the uplink subband is configured for the target BWP pair, the configuration of the uplink subband satisfies either one of the following:
configuring the uplink subband in an uplink BWP corresponding to the target BWP pair; or
configuring the uplink subband in a downlink BWP corresponding to the target BWP pair.

Optionally, in a case that the uplink subband is configured in a target BWP corresponding to the target BWP pair, a frequency-domain range of the uplink subband is entirely within a frequency-domain range corresponding to the target BWP, and the target BWP is the uplink BWP or the downlink BWP.

Optionally, the uplink subband is configured as a physical resource block PRB range, and a subcarrier spacing corresponding to the PRB range is a subcarrier spacing corresponding to the target BWP.

Optionally, the PRB range includes a starting PRB index and a quantity of PRBs contained in the PRB range, which are configured by the network-side device.

Optionally, in a case that the uplink subband is configured within the uplink BWP corresponding to the target BWP pair, all frequency-domain resources in the uplink subband are available for uplink transmission.

Optionally, in a case that the uplink subband is configured within the uplink BWP corresponding to the target BWP pair, and the first BWP is the downlink BWP, the determining module 401 is further configured to perform any one of the following:
in a case that the uplink subband is entirely within the downlink BWP, determine that in the target SBFD time-domain unit, all frequency-domain resources in the uplink subband are reserved for uplink transmission;
in a case that the uplink subband is partially within the downlink BWP, determine that in the target SBFD time-domain unit, a frequency-domain resource in the uplink subband that is contained within the downlink BWP is reserved for uplink transmission; or
in a case that the uplink subband is entirely outside the downlink BWP, determine that in the target SBFD time-domain unit, no frequency-domain resource in the downlink BWP is reserved for uplink transmission.

Optionally, in a case that the uplink subband is configured within the uplink BWP corresponding to the target BWP pair, the apparatus expects that the uplink subband is entirely within the downlink BWP.

Optionally, in a case that the uplink subband is configured within the downlink BWP corresponding to the target BWP pair, and the first BWP is the uplink BWP, the determining module 401 is further configured to perform any one of the following:
in a case that the uplink subband is entirely within the uplink BWP, determine that in the target SBFD time-domain unit, all frequency-domain resources in the uplink subband are available for uplink transmission;
in a case that the uplink subband is partially within the uplink BWP, determine that in the target SBFD time-domain unit, a frequency-domain resource in the uplink subband that is contained within the uplink BWP is available for uplink transmission; or
in a case that the uplink subband is entirely outside the uplink BWP, determine that in the target SBFD time-domain unit, no frequency-domain resource in the uplink subband is available for uplink transmission.

Optionally, in a case that the uplink subband is configured within the downlink BWP corresponding to the target BWP pair, the apparatus expects that the uplink subband is entirely within the uplink BWP, or the apparatus does not expect that the uplink subband is entirely outside the uplink BWP.

Optionally, in a case that the uplink subband is configured within the downlink BWP corresponding to the target BWP pair, and the first BWP is the downlink BWP, all frequency-domain resources in the uplink subband are reserved for uplink transmission.

Optionally, in a case that the uplink subband is configured for a target serving cell, the uplink subband includes at least one of the following parameters:
a preset subcarrier spacing;
a CRB index of the uplink subband; and
a quantity of CRBs included in the uplink subband.

Optionally, the preset subcarrier spacing is determined based on at least one of the following:
reusing a subcarrier spacing parameter in a time division duplex uplink and downlink configuration parameter;
independently configured by the network-side device; and
reusing a subcarrier spacing parameter of a second BWP of the terminal.

In this embodiment of this application, after obtaining the uplink subband that is configured by the network-side device for the SBFD operation, the apparatus can determine the frequency-domain resource available for the SBFD operation within the uplink BWP or the downlink BWP in the target SBFD time-domain unit, so that the apparatus can perform the SBFD operation on the frequency-domain resource available for the SBFD operation, to ensure performance of performing the SBFD by the apparatus, ensure flexible utilization of a spectrum resource, and improve resource utilization efficiency.

The uplink subband processing apparatus 400 in this embodiment of this application may be an electronic device, for example, an electronic device with an operating system, or may be a component in an electronic device, for example, an integrated circuit or a chip. The electronic device may be a terminal or another device other than a terminal. For example, the terminal may include, but is not limited to, the type of terminal 11 listed above, and the another device may be a server, a network attached storage (NAS), or the like. This is not specifically limited in embodiments of this application.

The uplink subband processing apparatus 400 according to this embodiment of this application may implement all processes implemented by the terminal in the method embodiment in FIG. 2, and achieve the same technical effects. Details are not described herein again to avoid repetition.

The uplink subband configuration method according to embodiments of this application may be performed by an uplink subband configuration apparatus. In embodiments of this application, the uplink subband configuration apparatus provided in embodiments of this application is described by using an example in which the uplink subband configuration apparatus performs the uplink subband configuration method.

FIG. 5 is a diagram of a structure of an uplink subband configuration apparatus according to an embodiment of this application. As shown in FIG. 5, the uplink subband configuration apparatus 500 includes:
a configuration module 501, configured to configure an uplink subband for an SBFD operation for a first object, where the uplink subband is used by a terminal to determine a frequency-domain resource available for the SBFD operation within a first BWP in a target SBFD time-domain unit, where
the first object is a target serving cell or a target BWP pair, and the first BWP is one of BWPs corresponding to the target BWP pair.

Optionally, in a case that the target BWP pair is a BWP pair used by the terminal to expect to perform the SBFD operation, the configuration module 501 is further configured to:
configure the uplink subband used for the SBFD operation for the target BWP pair.

Optionally, the configuration module 501 is further configured to perform either one of the following:
configure the uplink subband used for the SBFD operation within an uplink BWP corresponding to the target BWP pair; or
configure the uplink subband used for the SBFD operation within a downlink BWP corresponding to the target BWP pair.

Optionally, in a case that a frequency-domain range of the configured uplink subband is entirely within a frequency-domain range corresponding to a target BWP, the uplink subband is configured as a PRB range, and a subcarrier spacing corresponding to the PRB range is a subcarrier spacing corresponding to the target BWP; and

the target BWP is the uplink BWP or the downlink BWP.

Optionally, the configuration module 501 is further configured to:
configure a starting PRB index and a quantity of PRBs contained in the PRB range, which correspond to the PRB range.

Optionally, in a case that the uplink subband is configured for the target serving cell, the configuration module 501 is further configured to:
configure at least one of the following for the uplink subband:
a preset subcarrier spacing;
a CRB index of the uplink subband; and
a quantity of CRBs included in the uplink subband.

Optionally, in a case that the configuration of the uplink subband includes the preset subcarrier spacing, the configuration module 501 is further configured to:
determine the preset subcarrier spacing based on at least one of the following:
reusing a subcarrier spacing parameter in a time division duplex uplink and downlink configuration parameter;
independently configured; and
reusing a subcarrier spacing parameter of a second BWP of the terminal.

In this embodiment of this application, the apparatus can configure the uplink subband for the SBFD operation based on different configuration manners, so that the terminal can determine, for the configuration of the uplink subband, the frequency-domain resource available for the SBFD operation within the uplink BWP and/or the downlink BWP in the target SBFD time-domain unit, and perform the SBFD operation in the target SBFD time-domain unit based on the frequency-domain resource, to ensure performance of the SBFD, ensure flexible utilization of the frequency-domain resource by the terminal, and improve resource utilization efficiency, to dynamically adapt to service requirements.

The uplink subband configuration apparatus 500 according to this embodiment of this application may implement all processes implemented by the network-side device in the method embodiment in FIG. 3, and achieve the same technical effects. Details are not described herein again to avoid repetition.

Optionally, as shown in FIG. 6, an embodiment of this application further provides a communication device 600, including a processor 601 and a memory 602. The memory 602 stores a program and instructions that can be run on the processor 601. For example, when the communication device 600 is a terminal, and when the program or the instructions are executed by the processor 601, all steps of the uplink subband processing method in embodiments are implemented, and the same technical effects can be achieved. When the communication device 600 is a network-side device, and when the program or the instructions are executed by the processor 601, all steps of the uplink subband configuration method in embodiments are implemented, and the same technical effects can be achieved. To avoid repetition, details are not described herein again.

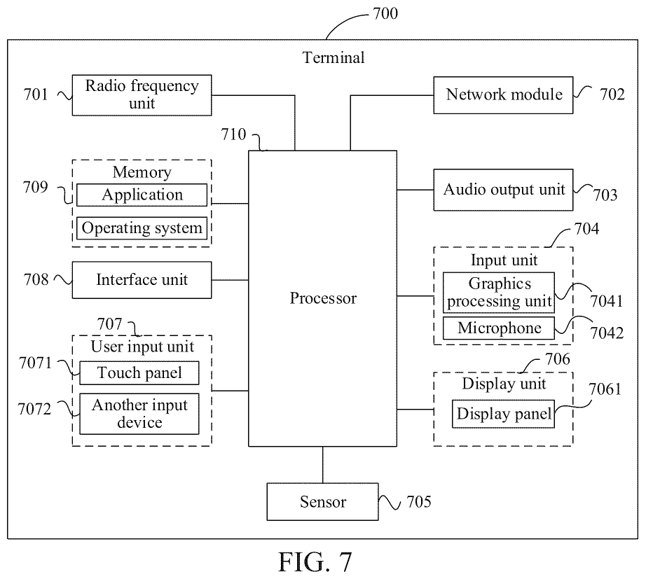

An embodiment of this application further provides a terminal, including a processor and a communication interface. The processor is configured to determine, based on an uplink subband configured by a network-side device, a frequency-domain resource available for an SBFD operation within a first BWP in a target SBFD time-domain unit, where the uplink subband is used for the SBFD operation; and the first BWP is one of BWPs corresponding to a target BWP pair. The terminal embodiment corresponds to the terminal side method embodiment described above, and each implementation process and implementation of the method embodiment described above may be used in the terminal embodiment, and the same technical effect can be achieved. Specifically, FIG. 7 is a diagram of a hardware structure of a terminal according to an embodiment of this application.

The terminal 700 includes but is not limited to: at least some of components of a radio frequency unit 701, a network module 702, an audio output unit 703, an input unit 704, a sensor 705, a display unit 706, a user input unit 707, an interface unit 708, a memory 709, a processor 710, and the like.

A person skilled in the art may understand that, the terminal 700 may further include a power supply (for example, a battery) for supplying power to the components. The power supply may be logically connected to the processor 710 by using a power management system, to implement functions such as charging, discharging, and power consumption management by using the power management system. The structure of the terminal shown in FIG. 7 constitutes no limitation on the terminal. The terminal may include more or fewer components than those shown in the figure, or combine some components, or have different component arrangements. Details are not described herein again.

It should be understood that, in this embodiment of this application, the input unit 704 may include a graphics processing unit (GPU) 7041 and a microphone 7042. The graphics processing unit 7041 performs processing on image data of a static image or a video that is obtained by an image capture device (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 and another input device 7072. The touch panel 7071 is alternatively referred to as a touchscreen. The touch panel 7071 may include two parts: a touch detection apparatus and a touch controller. The another input device 7072 may include, but is not limited to, a physical keyboard, a function button (such as a volume control button or a power button), a trackball, a mouse, and a joystick. Details are not described herein again.

In this embodiment of this application, after receiving downlink data from the network-side device, the radio frequency unit 701 may transmit the downlink data to the processor 710 for processing. In addition, the radio frequency unit 701 may send uplink data to the network-side device. Generally, the radio frequency unit 701 includes, but is not limited to, an antenna, an amplifier, a transceiver, a coupler, a low noise amplifier, a duplexer, and the like.

The memory 709 may be configured to store a software program or instructions and various data. The memory 709 may mainly include a first storage area for storing the program and the instructions and a second storage area for storing the data. The first storage area may store an operating system, an application or instructions required by at least one function (for example, a sound playback function, an image display function, and the like), and the like. In addition, the memory 709 may include a volatile memory or a non-volatile memory, or the memory 709 may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 709 in this embodiment of this application includes, but is not limited to, these memories and any memory of another proper type.

The processor 710 may include one or more processing units. Optionally, the processor 710 integrates an application processor and a modem processor. The application processor mainly processes an operation related to an operating system, a user interface, an application, and the like, and the modem processor mainly processes a wireless communication signal, for example, a baseband processor. It may be understood that, the modem processor may not be integrated into the processor 710.

The processor 710 is configured to:
determine, based on an uplink subband configured by a network-side device, a frequency-domain resource available for an SBFD operation within a first BWP in a target SBFD time-domain unit, where
the uplink subband is used for the SBFD operation; and the first BWP is one of BWPs corresponding to a target BWP pair.

In this embodiment of this application, after obtaining the uplink subband that is configured by the network-side device for the SBFD operation, the terminal 700 can determine the frequency-domain resource available for the SBFD operation within the uplink BWP or the downlink BWP in the target SBFD time-domain unit, so that the terminal 700 can perform the SBFD operation on the frequency-domain resource available for the SBFD operation, to ensure performance of performing the SBFD by the terminal 700, ensure flexible utilization of a spectrum resource, and improve resource utilization efficiency.

It should be noted that, the terminal 700 according to this embodiment of this application may implement all processes of the uplink subband processing method in FIG. 2, and achieve the same technical effects. To avoid repetition, details are not described herein again.

An embodiment of this application further provides a network-side device. The network-side device is a network node, including a processor and a communication interface. The processor is configured to: configure, an uplink subband for an SBFD operation for a first object, where the uplink subband is used by a terminal to determine a frequency-domain resource available for the SBFD operation within a first BWP in a target SBFD time-domain unit, where the first object is a target serving cell or a target BWP pair, and the first BWP is one of BWPs corresponding to the target BWP pair. The network-side device embodiment corresponds to the foregoing method embodiment in FIG. 3, and each implementation process and implementation of the method embodiment in FIG. 3 may be used in the network-side device embodiment, and the same technical effects can be achieved.

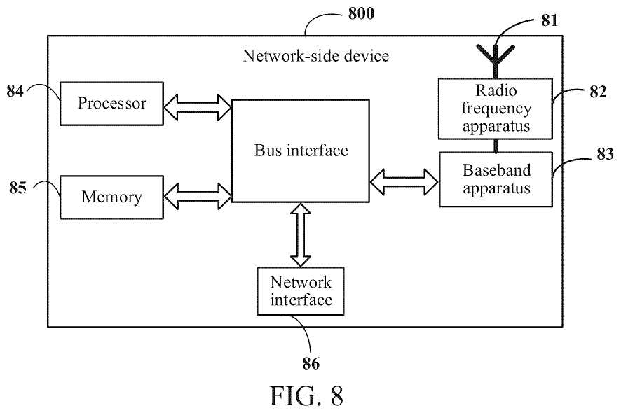

Specifically, an embodiment of this application further provides a network-side device. As shown in FIG. 8, the network-side device 800 includes: an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information through the antenna 81 and sends the received information to the baseband apparatus 83 for processing. In a downlink direction, the baseband apparatus 83 processes to-be-sent information and sends the information to the radio frequency apparatus 82, and the radio frequency apparatus 82 processes the received information and sends the information through the antenna 81.

The method performed by the network-side device in the foregoing embodiment may be implemented in the baseband apparatus 83. The baseband apparatus 83 includes a baseband processor.

The baseband apparatus 83 may include, for example, at least one baseband board, and a plurality of chips are disposed on the baseband board. As shown in FIG. 8, one of the chips is, for example, the baseband processor, connected to the memory 85 through a bus interface, to invoke a program in the memory 85, and perform an operation performed by the network device shown in the foregoing method embodiment.

The network-side device may further include a network interface 86. The interface is, for example, a common public radio interface (CPRI).

Specifically, the network-side device 800 in this embodiment of this application further includes: instructions or a program stored in the memory 85 and run on the processor 84. The processor 84 invokes the instructions or the program in the memory 85, to perform the methods performed by the modules shown in FIG. 5, and same technical effects are achieved. To avoid repetition, details are not described herein again.

An embodiment of this application further provides a readable storage medium. The readable storage medium stores a program or instructions, and when the program or the instructions are executed by a processor, all processes of the method embodiment in FIG. 2 or FIG. 3 are implemented, and the same technical effects can be achieved. To avoid repetition, details are not described herein again.

The processor is the processor in the terminal described in the foregoing embodiment. The readable storage medium may be non-volatile or non-transient. The readable storage medium may include a computer-readable storage medium, for example, a computer read only memory ROM, a random access memory RAM, a magnetic or an optical disc, and the like.

An embodiment of this application further provides a chip. The chip includes a processor and a communication interface. The communication interface is coupled to the processor, and the processor is configured to run a program or instructions, to implement all processes of the method embodiment in FIG. 2 or FIG. 3, and same technical effects can be achieved. To avoid repetition, details are not described herein again.

It should be understood that, the chip in this embodiment of this application may alternatively be referred to as a system-level chip, a system chip, a chip system, a system-on-chip, or the like.

An embodiment of this application further provides a computer program/program product. The computer program/program product is stored in a storage medium. The computer program/program product is executed by at least one processor, to implement all processes of the method embodiment in FIG. 2 or FIG. 3, and same technical effects can be achieved. To avoid repetition, details are not described herein again.

An embodiment of this application further provides a communication system, including: a terminal and a network-side device, where the terminal may be configured to perform steps of the method embodiment in FIG. 2, and the network-side device may be configured to perform steps of the method embodiment in FIG. 3.

It should be noted that, the terms “include”, “comprise”, or any other variation thereof in this specification is intended to cover a non-exclusive inclusion, so that a process, a method, an article, or an apparatus that includes a list of elements not only includes those elements but also includes other elements that are not expressly listed, or further includes elements inherent to such a process, a method, an article, or an apparatus. An element preceded by “includes a” does not, without more constraints, preclude the presence of additional identical elements in the process, the method, the article, or the apparatus that includes the element. In addition, it should be noted that, scopes of the method and the apparatus in the implementations of this application are not limited to performing functions in an order shown or discussed, but may include performing functions in a substantially concurrent manner or in reverse order depending on functionality involved. For example, the methods described may be performed in an order different from that described, and various steps may alternatively be added, omitted, or combined. In addition, characteristics described with reference to some examples may alternatively be combined in another example.

According to the descriptions of the foregoing implementations, a person skilled in the art may clearly understand that the method according to the foregoing embodiment may be implemented by software in addition to necessary universal hardware platform, or by using hardware. In many cases, the former is a better implementation. Based on such an understanding, the technical solutions of this application essentially or the part contributing to the conventional technology may be implemented in a form of a computer software product. The computer software product is stored in a storage medium (such as a ROM/RAM, a magnetic disk, or an optical disc) and includes several indications for instructing a terminal (which may be a mobile phone, a computer, a server, an air conditioner, a network device, or the like) to perform the methods described in embodiments of this application.

Embodiments of this application are described with reference to the accompanying drawings. This application is not limited to the specific implementations described above, and the specific implementations described above are merely examples and not limited. A person of ordinary skill in the art may also make various variations under the inspiration of this application and without departing from the purpose of this application and the protection scope of the claims, and such variations shall all fall within the protection scope of this application.

What is claimed is:

1. An uplink subband processing method, comprising:
determining, by a terminal based on an uplink subband configured by a network-side device, a frequency-domain resource available for an SBFD operation within a first bandwidth part (BWP) in a target subband full duplex (SBFD) time-domain unit, wherein
the uplink subband is used for the SBFD operation; and the first BWP is one of BWPs corresponding to a target BWP pair.

2. The method according to claim 1, wherein the method further comprises:
performing, by the terminal based on the frequency-domain resource, the SBFD operation in the target SBFD time-domain unit.

3. The method according to claim 2, wherein in a case that the uplink subband is configured for a target serving cell, the determining a frequency-domain resource available for an SBFD operation within a first BWP in a target SBFD time-domain unit comprises:
determining, by the terminal based on a relationship between the first BWP and the uplink subband in frequency domain, the frequency-domain resource available for the SBFD operation within the first BWP in the target SBFD time-domain unit, wherein
the target BWP pair corresponds to the target serving cell.

4. The method according to claim 3, wherein the determining, by the terminal based on a relationship between the first BWP and the uplink subband in frequency domain, the frequency-domain resource available for the SBFD operation within the first BWP in the target SBFD time-domain unit comprises either one of the following:
in a case that the first BWP is an uplink BWP corresponding to the target BWP pair, determining, by the terminal, a frequency-domain resource available for uplink transmission within the uplink BWP in the target SBFD time-domain unit; or
in a case that the first BWP is a downlink BWP corresponding to the target BWP pair, determining, by the terminal, a frequency-domain resource reserved for uplink transmission within the downlink BWP in the target SBFD time-domain unit.

5. The method according to claim 4, wherein the determining, by the terminal, a frequency-domain resource available for uplink transmission within the uplink BWP in the target SBFD time-domain unit comprises any one of the following:
in a case that the uplink subband is entirely within the uplink BWP, determining, by the terminal, that in the target SBFD time-domain unit, all frequency-domain resources in the uplink subband are available for uplink transmission;
in a case that the uplink subband is partially within the uplink BWP, determining, by the terminal, that in the target SBFD time-domain unit, a frequency-domain resource in the uplink subband that is contained within the uplink BWP is available for uplink transmission; or
in a case that the uplink subband is entirely outside the uplink BWP, determining, by the terminal, that in the target SBFD time-domain unit, no frequency-domain resource in the uplink subband is available for uplink transmission.

6. The method according to claim 5, wherein the performing, by the terminal based on the frequency-domain resource, the SBFD operation in the target SBFD time-domain unit comprises either one of the following:
in a case that the uplink subband is partially within the uplink BWP, and a quantity of frequency-domain resources in the uplink subband that are contained within the uplink BWP is greater than or equal to a preset first threshold, determining, by the terminal, to perform the SBFD operation in the target SBFD time-domain unit; or
in a case that the uplink subband is partially within the uplink BWP, and a ratio of a quantity of frequency-domain resources in the uplink subband that are contained within the uplink BWP to a quantity of frequency-domain resources of a first object is greater than or equal to a preset first ratio, determining, by the terminal, to perform the SBFD operation in the target SBFD time-domain unit, wherein the first object is any one of the uplink BWP, the uplink subband, or a component carrier.

7. The method according to claim 2, wherein the performing, by the terminal based on the frequency-domain resource, the SBFD operation in the target SBFD time-domain unit comprises:
in a case that target uplink transmission is configured or scheduled in the target SBFD time-domain unit, determining, by the terminal, whether the target uplink transmission is valid, wherein
the target uplink transmission corresponds to the target BWP pair.

8. The method according to claim 7, wherein the determining whether the target uplink transmission is valid comprises any one of the following:
in a case that any frequency-domain resource occupied by the target uplink transmission is available for uplink transmission, determining, by the terminal, that the target uplink transmission is valid; or
in a case that at least one of the frequency-domain resources occupied by the target uplink transmission is not available for uplink transmission, determining, by the terminal, that the target uplink transmission is invalid; or in a case that at least one of the frequency-domain resources occupied by the target uplink transmission is available for uplink transmission, determining, by the terminal, that the target uplink transmission is valid.

9. The method according to claim 8, wherein in a case that at least one of the frequency-domain resources occupied by the target uplink transmission is not available for uplink transmission, the method further comprises:
in a case that the target SBFD time-domain unit is a semi-static flexible time-domain unit, and the target uplink transmission is scheduled uplink transmission, determining, by the terminal, that the target SBFD time-domain unit is reverted to a non-SBFD time-domain unit, and the target uplink transmission is valid, wherein
the terminal does not perform the SBFD operation in the non-SBFD time-domain unit; or,
wherein in a case that at least one of the frequency-domain resources occupied by the target uplink transmission is available for uplink transmission, the method further comprises:
determining, by the terminal, a first set based on a first frequency-domain resource, and performing uplink transmission based on the first set; or
removing, by the terminal, a frequency-domain resource that does not conform to a predefined rule in the first set to obtain a first target subset, and performing uplink transmission based on the first target subset, wherein
the first frequency-domain resource is any frequency-domain resource that is available for uplink transmission in the frequency-domain resources occupied by the target uplink transmission; or,
wherein in a case that at least one of the frequency-domain resources occupied by the target uplink transmission is available for uplink transmission, the determining, by the terminal, that the target uplink transmission is valid comprises any one of the following:
in a case that at least one of the frequency-domain resources occupied by the target uplink transmission is available for uplink transmission, and a quantity of frequency-domain resources available for uplink transmission is greater than or equal to a preset second threshold, determining, by the terminal, that the target uplink transmission is valid;
in a case that at least one of the frequency-domain resources occupied by the target uplink transmission is available for uplink transmission, and a ratio of a quantity of frequency-domain resources available for uplink transmission to a quantity of all frequency-domain resources occupied by the target uplink transmission is greater than or equal to a preset second ratio, determining, by the terminal, that the target uplink transmission is valid;
in a case that at least one of the frequency-domain resources occupied by the target uplink transmission is available for uplink transmission, and a quantity of frequency-domain resources, which are obtained after the terminal removes any frequency-domain resource that does not conform to a predefined rule from the frequency-domain resources available for uplink transmission, is greater than or equal to a preset third threshold, determining, by the terminal, that the target uplink transmission is valid; or
in a case that at least one of the frequency-domain resources occupied by the target uplink transmission is available for uplink transmission, and a ratio of a quantity of frequency-domain resources, which are obtained after the terminal removes any frequency-domain resource that does not conform to a predefined rule from the frequency-domain resources available for uplink transmission, to a quantity of all frequency-domain resources occupied by the target uplink transmission is greater than or equal to a preset third ratio, determining, by the terminal, that the target uplink transmission is valid.

10. The method according to claim 4, wherein the determining, by the terminal, a frequency-domain resource reserved for uplink transmission within the downlink BWP in the target SBFD time-domain unit comprises any one of the following:
in a case that the uplink subband is entirely within the downlink BWP, determining, by the terminal, that in the target SBFD time-domain unit, all frequency-domain resources in the uplink subband are reserved for uplink transmission;
in a case that the uplink subband is partially within the downlink BWP, determining, by the terminal, that in the target SBFD time-domain unit, a frequency-domain resource in the uplink subband that is contained within the downlink BWP is reserved for uplink transmission; or
in a case that the uplink subband is entirely outside the downlink BWP, determining, by the terminal, that in the target SBFD time-domain unit, no frequency-domain resource in the downlink BWP is reserved for uplink transmission;
wherein the performing, by the terminal based on the frequency-domain resource, the SBFD operation in the target SBFD time-domain unit comprises:
in a case that target downlink transmission is configured or scheduled in the target SBFD time-domain unit, determining, by the terminal, whether the target downlink transmission is valid, wherein
the target downlink transmission corresponds to the target BWP pair.

11. The method according to claim 10, wherein the determining whether the target downlink transmission is valid comprises any one of the following:
in a case that any frequency-domain resource occupied by the target downlink transmission is not reserved for uplink transmission, determining, by the terminal, that the target downlink transmission is valid; or
in a case that at least one of the frequency-domain resources occupied by the target downlink transmission is reserved for uplink transmission, determining, by the terminal, that the target downlink transmission is invalid; or in a case that at least one of the frequency-domain resources occupied by the target downlink transmission is not reserved for uplink transmission, determining, by the terminal, that the target downlink transmission is valid.

12. The method according to claim 11, wherein in a case that any frequency-domain resource occupied by the target downlink transmission is not reserved for uplink transmission, the method further comprises:
for the target downlink transmission configured or scheduled within the target BWP pair in the target SBFD time-domain unit, expecting, by the terminal, that all frequency-domain resources occupied by the target downlink transmission are not reserved for uplink transmission; or,
wherein in a case that at least one of the frequency-domain resources occupied by the target downlink transmission is reserved for uplink transmission, the method further comprises:
in a case that the target SBFD time-domain unit is a semi-static flexible time-domain unit, and the target downlink transmission is scheduled downlink transmission, determining, by the terminal, that the target SBFD time-domain unit is reverted to a non-SBFD time-domain unit, and the target downlink transmission is valid, wherein
the terminal does not perform the SBFD operation in the non-SBFD time-domain unit; or,
wherein in a case that at least one of the frequency-domain resources occupied by the target downlink transmission is not reserved for uplink transmission, the method further comprises:
determining, by the terminal, a second set based on a second frequency-domain resource, and performing downlink transmission based on the second set; or
removing, by the terminal, a frequency-domain resource that does not conform to a predefined rule in the second set to obtain a second target subset, and performing downlink transmission based on the second target subset, wherein
the second frequency-domain resource is any frequency-domain resource that is not reserved for uplink transmission in the frequency-domain resources occupied by the downlink transmission; or,
wherein in a case that at least one of the frequency-domain resources occupied by the target downlink transmission is not reserved for uplink transmission, the determining, by the terminal, that the target downlink transmission is valid comprises any one of the following:
in a case that at least one of the frequency-domain resources occupied by the target downlink transmission is not reserved for uplink transmission, and a quantity of frequency-domain resources not reserved for uplink transmission is greater than or equal to a preset fourth threshold, determining, by the terminal, that the target downlink transmission is valid;
in a case that at least one of the frequency-domain resources occupied by the target downlink transmission is not reserved for uplink transmission, and a ratio of a quantity of frequency-domain resources not reserved for uplink transmission to a quantity of all frequency-domain resources occupied by the target downlink transmission is greater than or equal to a preset third ratio, determining, by the terminal, that the target downlink transmission is valid;
in a case that at least one of the frequency-domain resources occupied by the target downlink transmission is not reserved for uplink transmission, and a quantity of frequency-domain resources, which are obtained after the terminal removes any frequency-domain resource that does not conform to a predefined rule from the frequency-domain resources that are not reserved for uplink transmission, is greater than or equal to a preset fourth threshold, determining, by the terminal, that the target downlink transmission is valid; or
in a case that at least one of the frequency-domain resources occupied by the target downlink transmission is not reserved for uplink transmission, and a ratio of a quantity of frequency-domain resources, which are obtained after the terminal removes any frequency-domain resource that does not conform to a predefined rule from the frequency-domain resources that are not reserved for uplink transmission, to a quantity of all frequency-domain resources occupied by the target downlink transmission is greater than or equal to a preset fourth ratio, determining, by the terminal, that the target downlink transmission is valid.

13. The method according to claim 1, wherein in a case that the uplink subband is configured for a target serving cell, the determining, by a terminal based on an uplink subband configured by a network-side device, a frequency-domain resource available for an SBFD operation within a first bandwidth part (BWP) in a target SBFD time-domain unit comprises:
in a case that the network-side device configures the terminal to perform the SBFD operation in the target BWP pair, determining, by the terminal based on a relationship between the first BWP and the uplink subband in frequency domain, the frequency-domain resource available for the SBFD operation within the first BWP in the target SBFD time-domain unit;
wherein in a case that the first BWP is an uplink BWP, a relationship between the uplink BWP and the uplink subband in frequency domain comprises either one of the following:
the uplink subband is entirely within the uplink BWP; or
the uplink subband is partially within the uplink BWP.

14. The method according to claim 1, wherein in a case that the uplink subband is configured for the target BWP pair, the configuration of the uplink subband satisfies either one of the following:
configuring the uplink subband in an uplink BWP corresponding to the target BWP pair; or
configuring the uplink subband in a downlink BWP corresponding to the target BWP pair.

15. The method according to claim 14, wherein in a case that the uplink subband is configured in a target BWP corresponding to the target BWP pair, a frequency-domain range of the uplink subband is entirely within a frequency-domain range corresponding to the target BWP, and the target BWP is the uplink BWP or the downlink BWP;
wherein the uplink subband is configured as a physical resource block (PRB) range, and a subcarrier spacing corresponding to the PRB range is a subcarrier spacing corresponding to the target BWP;
wherein the PRB range comprises a starting PRB index and a quantity of PRBs contained in the PRB range, which are configured by the network-side device.

16. The method according to claim 14, wherein in a case that the uplink subband is configured within the uplink BWP corresponding to the target BWP pair, all frequency-domain resources in the uplink subband are available for uplink transmission; or,
wherein in a case that the uplink subband is configured within the uplink BWP corresponding to the target BWP pair, and the first BWP is the downlink BWP, determining, by the terminal based on a relationship between the first BWP and the uplink subband in frequency domain, the frequency-domain resource available for the SBFD operation in the target SBFD time-domain unit comprises any one of the following:
in a case that the uplink subband is entirely within the downlink BWP, determining, by the terminal, that in the target SBFD time-domain unit, all frequency-domain resources in the uplink subband are reserved for uplink transmission;
in a case that the uplink subband is partially within the downlink BWP, determining, by the terminal, that in the target SBFD time-domain unit, a frequency-domain resource in the uplink subband that is contained within the downlink BWP is reserved for uplink transmission; or
in a case that the uplink subband is entirely outside the downlink BWP, determining, by the terminal, that in the target SBFD time-domain unit, no frequency-domain resource in the downlink BWP is reserved for uplink transmission; or,
wherein in a case that the uplink subband is configured within the uplink BWP corresponding to the target BWP pair, expecting, by the terminal, that the uplink subband is entirely within the downlink BWP.

17. The method according to claim 14, wherein in a case that the uplink subband is configured within the downlink BWP corresponding to the target BWP pair, and the first BWP is the uplink BWP, determining, by the terminal based on a relationship between the first BWP and the uplink subband in frequency domain, the frequency-domain resource available for the SBFD operation in the target SBFD time-domain unit comprises any one of the following:
in a case that the uplink subband is entirely within the uplink BWP, determining, by the terminal, that in the target SBFD time-domain unit, all frequency-domain resources in the uplink subband are available for uplink transmission;
in a case that the uplink subband is partially within the uplink BWP, determining, by the terminal, that in the target SBFD time-domain unit, a frequency-domain resource in the uplink subband that is contained within the uplink BWP is available for uplink transmission; or
in a case that the uplink subband is entirely outside the uplink BWP, determining, by the terminal, that in the target SBFD time-domain unit, no frequency-domain resource in the uplink subband is available for uplink transmission; or,
wherein in a case that the uplink subband is configured within the downlink BWP corresponding to the target BWP pair, expecting, by the terminal, that the uplink subband is entirely within the uplink BWP, or not expecting, by the terminal, that the uplink subband is entirely outside the uplink BWP; or,
wherein in a case that the uplink subband is configured within the downlink BWP corresponding to the target BWP pair, and the first BWP is the downlink BWP, all frequency-domain resources in the uplink subband are reserved for uplink transmission.

18. An uplink subband configuration method, comprising:
configuring, by a network-side device, an uplink subband for an SBFD operation for a first object, wherein the uplink subband is used by a terminal to determine a frequency-domain resource available for the SBFD operation within a first BWP in a target SBFD time-domain unit, wherein
the first object is a target serving cell or a target BWP pair, and the first BWP is one of BWPs corresponding to the target BWP pair.

19. A terminal, comprising a processor and a memory, wherein the memory stores a program or instructions that can be run on the processor, wherein the program or the instructions, when executed by the processor, cause the processor to perform:
determining based on an uplink subband configured by a network-side device, a frequency-domain resource available for an SBFD operation within a first bandwidth part (BWP) in a target subband full duplex (SBFD) time-domain unit, wherein
the uplink subband is used for the SBFD operation; and the first BWP is one of BWPs corresponding to a target BWP pair.

20. A network-side device, comprising a processor and a memory, wherein the memory stores a program or instructions that can be run on the processor, and when the program or the instructions are executed by the processor, steps of the uplink subband configuration method according to claim 18 are implemented.
